(19) United States
(12) Patent Application Publication
(10) Pub. No.: US 2003/0076319 A1
(43) Pub. Date: Apr. 24, 2003

(54) Method and apparatus for encoding and decoding an object

(76) Inventor: Masaki Hiraga, Tokyo (JP)

Correspondence Address: Dowell & Dowell, P.C., Suite 309, 1215 Jefferson Davis Highway, Arlington, VA, 22202, US

(21) Appl. No.: 09/972,925

(22) Filed: Oct. 10, 2001

(51) Int. Cl. G06T 17/00; G06T 15/30; G06T 17/20

(52) U.S. Cl. 345/420; 345/423

(57) ABSTRACT

Object encoding and decoding methods that encode and decode a surface of an object are provided. The method uses a distance function defined on the surface of the object. In particular, when the object is represented by a polygon mesh, the function outputs a graph distance from a base vertex in the polygon mesh to a specific vertex. The surface of the object is then decomposed into a plurality of shape components on the basis of the graph distance. The shape components are then encoded. The encoded data can include a description indicating that the object is a non-manifold if the shape represented by the polygon mesh is a non-manifold.

### BACKGROUND OF THE INVENTION

1. Field of the Invention

The present invention relates to an object encoding and decoding technique. It particularly relates to a method and an apparatus for encoding and decoding an object, that has a surface described as a polygon mesh.

2. Description of the Related Art

The widespread use of the Internet gives an opportunity for people to access an enormous amount of information without any special facilities. As this convenience has become understood, electronic commerce using the Internet has developed rapidly. In particular, online shopping in which orders of commodities are made based on published catalogs, has lately drawn public attention as one of the attractive uses of electronic commerce.

One of the most important points of online shopping is how to show commodities attractively. To show a photograph of the commodity can be effective for this purpose, but when users want to look at the commodity from different angles, it is hard to meet such a requirement with a 2-dimensional photograph. Therefore, as a recent trend, commodities are often modeled as polygon data so that the users can freely manipulate the 3-dimensional model through magnification, rotation, and the like.

However, when commodities are represented as polygon data, the amount of data required raises problems. The polygon data required for one commodity could be several megabytes if designed to show the fine structure of the commodity. Such large data sizes are difficult to manipulate and users cannot have the same feeling as when they look at paper catalog pages or the like. The success of online shopping depends on how quickly commodity image can be transmitted and displayed and how the image data and 3-dimensional information can be stored in a limited space of storage devices.

### SUMMARY OF THE INVENTION

The present invention has been made in view of the above-mentioned problems. One of the objects of the invention is to provide a technology for encoding and decoding polygon mesh data of objects such as commodities. Another object of the invention is to provide a technology for providing useful indices for the object at the same time when its polygon data are compressed. Yet another object of the present invention is to provide a technology for encoding and decoding the polygon data by which the encoded polygon data can be decoded in a short time. Still another object of the present invention is to provide a technology for properly encoding and decoding the polygon data with a fine structure that may not exist in reality.

According to one aspect of the present invention, an object encoding method is provided. The method comprises obtaining a description of a surface of an object, defining an origin on the surface, decomposing the surface into a plurality of independent shape components according to a distance from the origin to a point of the surface, and encoding the shape components. If the object is described as a polygon mesh, the origin may be a predefined base vertex in the polygon mesh, and the distance may be a graph distance from the base vertex to a vertex of the polygon mesh.

The graph distance may be defined, for example, as the number of edges or the distance along a path from a base vertex to another vertex. In particular, in some cases, such as where the distance is defined as the number of edges, the distance may be represented by a natural number. The shape components may include a contour graph that is a set of edges that connect vertices that have the same graph distance. Roughly speaking, the shape components can be independent regions each of which is a slice of the object sliced starting from the base vertex. Once the distance, particularly a graph distance, is introduced, the object can be easily decomposed into the shape components uniformly. Furthermore, since each of the shape components is an independent region, it can be easily encoded. The shape components include global topological information of the object. Here, global topological information is intended to exclude local topological information such as connectivity information between polygon vertices. Examples of global topological information are a structural graph or a skeleton structure obtained on the basis of the graph distance. The global topological information is useful as an index of the object for searching purposes.

The encoding the shape components may include encoding geometrical information of the object and encoding local topological information of the object. An example of local topological information is connectivity information between polygon vertices. The encoding of the local topological information may include a description indicating that the object is a non-manifold when a shape represented by the polygon mesh is a non-manifold. In this case, the description may describe the number of sets of polygons such as triangles around a vertex that characterizes the non-manifold. The description may also describe the number of planes around a vertex that characterizes the non-manifold.

The encoding the geometrical information may be adapted to a local size of the polygon mesh. As an example, the difference between a predicted value and a real value of a vertex under consideration may be encoded by an entropy coding. The difference may be adjusted so that the entropy coding can be optimized. The geometrical information may include information relating to color or a normal of a vertex and a plane. In this case, the difference between a predicted value and a real value of such information may be encoded by the entropy coding.

According to another aspect of the present invention, an object decoding method is provided. The decoding method may be used in combination with the object encoding method of the present invention. The method comprises obtaining encoded data which describes a surface of an object, extracting a plurality of independent encoded shape components which are encoded after being decomposed according to a distance from an origin of the surface, which is included in the encoded data, to a point of the surface, and decoding the encoded shape components.

According to still another aspect of the present invention, an object encoding apparatus is provided. The apparatus embodies the above-mentioned object encoding method and comprises a unit which obtains a description of a surface of an object, a unit which defines an origin on the surface, a unit which decomposes the surface into a plurality of independent shape components according to a distance from the origin to a point of the surface, and a unit which encodes the shape components.

According to still another aspect of the present invention, an object decoding apparatus is provided. The apparatus embodies said object decoding method and can be used in combination with said object encoding apparatus. The apparatus comprises a unit which obtains encoded data which describe a surface of an object, a unit which extracts a plurality of independent encoded shape components which are encoded after being decomposed according to a distance from an origin of the surface, which is included in the encoded data, to a point of the surface, and a unit which decodes the encoded shape components.

According to still another aspect of the present invention, an object encoding method is provided. The method comprises obtaining an object, defining a function relating to a distance on a surface of the object, obtaining a structural graph of the object on a basis of a value of the function, and encoding the object in such a form that the structural graph is included. The structural graph may be explicitly or implicitly included in the encoded data. The encoded object data may be in such a form that the structural graph can be reconstructed or referred to for a future use. When the object is represented as a polygon mesh, the function may output the number of polygon edges along the path from a predefined base vertex in the polygon mesh to a vertex of the polygon mesh.

Moreover, any arbitrary combination of the above-mentioned structural components in the present invention is still effective as an embodiment when applied as a method, a system, a server, a terminal, a computer program, and so forth.

This summary of the invention does not necessarily describe features that must be included. The invention may also be a sub-combination of these described features.

### BRIEF DESCRIPTION OF THE DRAWINGS

The above and the other objects, features, and advantages, will become more apparent from the following description of preferred embodiments taken in conjunction with the accompanying drawings wherein:

FIG. 1 shows the relation among indices of singularities, k-cells, and objects to be coded with them;

FIG. 2a shows one pair of surfaces with the same sequence of Morse indices;

FIG. 2b shows another pair of surfaces with the same sequence of Morse indices;

FIG. 2c shows still another pair of surfaces with the same sequence of Morse indices;

FIG. 3a illustrates the relation between a torus and its critical points;

FIG. 3b illustrates the relation between a torus and its cross sectional contours;

FIG. 3c illustrates the relation between a torus and its Reeb graph;

FIG. 4a shows a parent-child relation of contours;

FIG. 4b shows a tree structure of contours having a parent-child relation;

FIG. 5 is a diagram explaining a method for encoding a torus using operators;

FIG. 6 shows an example of programming operators in pseudo-Pascal code;

FIG. 7 shows an example of programming operators in pseudo-Pascal code;

FIG. 8 shows an example of programming operators in pseudo-Pascal code;

FIG. 9 shows icons corresponding to cells;

FIG. 10 shows the pasting of cells;

FIG. 11 shows an example of the Reeb graph of an object constructed with icons;

FIGS. 12(1) , 12(2) , 12(3) , 12(4) , 12(5) , 12(6) , 12(7) , 12(8) , 12(9) , 12(10) , 12(11) , and 12(12) show the cross sectional contours of an object;

FIG. 13 is a list of operators for constructing an object;

FIG. 14 shows a homotopic transformation of contours;

FIG. 15 shows four main parameters of an operator;

FIG. 16 shows gradual transformation of an upper contour into a lower one using a guiding curve;

FIG. 17 shows various types of shape components of an embodiment;

FIG. 18 shows a marching pattern;

FIG. 19 shows a triangle strip of an annulus;

FIG. 20 shows a triangle strip of a 2-cell;

FIG. 21 shows shape components constructed when a single base vertex is specified;

FIG. 22 shows shape components constructed when several base vertices are specified;

FIGS. 23(a) to 23(t) show how connectivity information is encoded;

FIG. 24 shows one example of a non-manifold object;

FIG. 25 shows another example of a non-manifold object;

FIG. 26 illustrates how the connectivity information is encoded by using a toroidal graph;

FIG. 27 shows a compression method using connectivity prediction;

FIG. 28 is a block diagram showing an object encoding apparatus of the embodiment;

FIG. 29 is a block diagram showing an object decoding apparatus of the embodiment.

### DETAILED DESCRIPTION OF THE INVENTION

Although the preferred embodiments of the present invention will be described herein, the true scope of the present invention is broader than that of these preferred embodiments and is more particularly described in the claims. Prior to describing the embodiments, the following “base techniques” are introduced in order to help explain the subject area. These “base techniques” are based on a dissertation given by Dr. Yoshihisa Shinagawa of Tokyo University, in 1993. The full dissertation may be helpful for understanding the present invention.

Base Techniques

[1] Surface Coding Based on Morse Theory

(1) Introduction

The shape of a solid or a surface in 3D space is generally represented as a sequence of symbols for coding. The coding herein means an object expression using necessary information for modeling an object. In the case of natural objects, a shape can have so many degrees of freedom that coding them demands certain simplification. Topology is a mathematical means for performing such simplifications.

3D objects may be interpreted using Morse theory as a mathematical tool. As it is described later, the objects can be modeled very effectively and consistently. However, Morse theory alone is not sufficient for precise 3D surface coding. The following explains the reasons for this, and describes a way to solve the problem by developing some effective extensions to Morse theory.

(2) Classical Morse Theory

Morse theory was primarily motivated by the calculus of variations, where the problem is describing the minima of a functional on an infinite dimensional space of paths. Conversely, one can also use the minima of a functional to describe some topological features of spaces that are otherwise hardly describable. The following is a brief overview of Morse theory.

1. Differentiable Manifolds

The spaces to which Morse theory can be applied are differentiable manifolds. Finite dimensional manifolds will next be considered.

Given an integer n, an n-dimensional manifold is a topological space such that any point has a neighborhood that can be mapped, one-to-one and bicontinuously, on a subset of the n-dimensional space Rⁿ. Such a mapping is called a chart and provides coordinates for the points in its domain, which correspond to latitude and longitude in the case of the globe. For the manifolds to be p times differentiable, the transformation from one coordinate system to another should also be p times differentiable for points in the range of two different charts.

One can thus see a manifold as being made of pieces of Rⁿ overlapping in a differentiable way. For instance, a line and a circle can be given with structures of 1-dimensional manifolds, and the surface of a sphere can be made a 2-manifold using at least two charts. One can make the surface of a torus a 2-manifold using at least four charts. Removing knotted circles from R³ gives examples of 3-manifolds, and higher dimensional manifolds appear concretely as, for example, configuration spaces of robot arms.

2. Differentiable Mapping and Singularities

Using charts, mapping from a p-manifold to an n-manifold can be numerically expressed as mapping from pieces of R^{p} to pieces of Rⁿ. For this mapping, one can check differentiability: A mapping is of class C^{k} if its components are k times continuously differentiable.

Let's define a height function on coordinates, which returns the height of a given point (such as z-coordinate of an object embedded in 3D-space). Jacobian matrix of a height function h: R²→R is given as

$$J = ( \begin{matrix}\frac{\partial h}{\partial {x}_{1}} \\ \frac{\partial h}{\partial {x}_{2}}\end{matrix} )$$

One can compute a Jacobian matrix at each point. Its rank is at most min(n, p). Points at which the rank of the Jacobian matrix reaches this maximal value are called “regular points”, while the others are called “singular points” or “critical points”. Singular points concerning the height function include “peak points” (“maxima”) , “saddle points” and “pits” (“minima”). In other words, at singular points, the vector of Jacobian matrix becomes zero, and the normal vector is oriented in the same direction as that of height.

3. Hessian Matrix and Index

For a mapping from an n-manifold to R (we call such mapping “functions on a manifold”) , a point is critical if and only if all partial derivatives are null. At such a point the aforementioned function is thus approximated by a quadratic form based on second order partial derivatives, the matrix of which is called the Hessian matrix, and its components are described as follows:

$$h = ( \begin{matrix}\frac{{\partial }^{2} f}{\partial {x}_{1}^{2}} & \frac{{\partial }^{2} f}{\partial {x}_{1} \partial {x}_{2}} & ⋯ & \frac{{\partial }^{2} f}{\partial {x}_{1} \partial {x}_{n}} \\ \frac{{\partial }^{2} f}{\partial {x}_{2} \partial {x}_{1}} & \frac{{\partial }^{2} f}{\partial {x}_{2}^{2}} & ⋯ & \frac{{\partial }^{2} f}{\partial {x}_{2} \partial {x}_{n}} \\ ⋯ & ⋯ & ⋯ & ⋯ \\ \frac{{\partial }^{2} f}{\partial {x}_{n} \partial {x}_{1}} & \frac{{\partial }^{2} f}{\partial {x}_{n} \partial {x}_{2}} & ⋯ & \frac{{\partial }^{2} f}{\partial {x}_{n}^{2}}\end{matrix} )$$

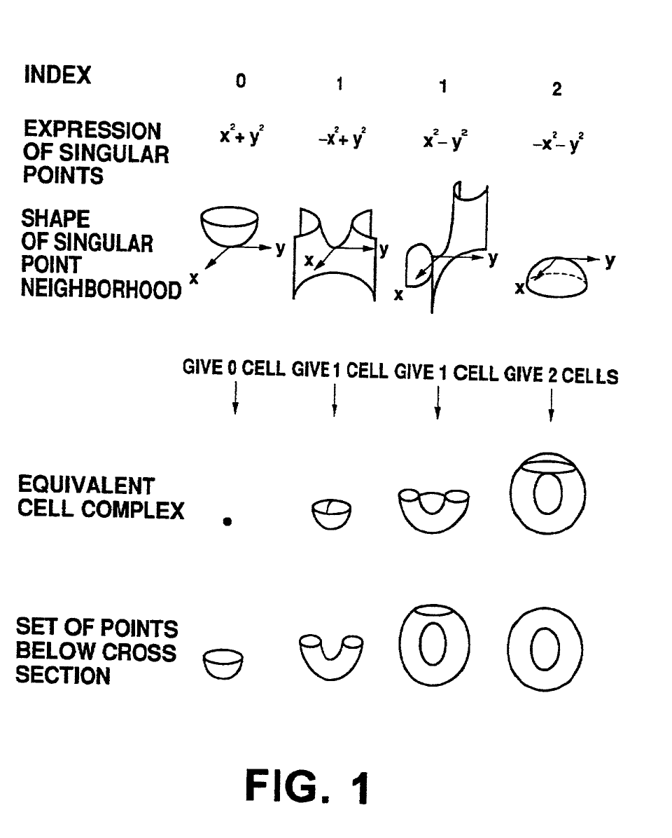

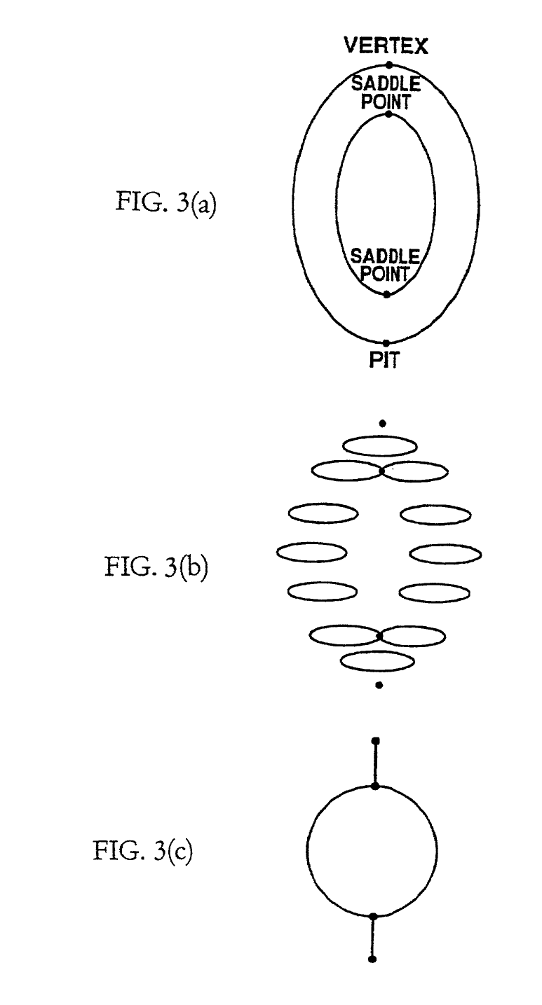

The number of negative definite Hessian matrix at the singular point is called the index of the singularity. As shown in FIG. 1, the index is also equal to the number of minus signs in the reduced form. Indices of peak point, saddle point and pit are 2, 1 and 0, respectively. As shown in FIGS. 3a-3c, a torus has one, two and one critical points having indices 2, 1 and 0, respectively.

A singularity is not degenerate if the Hessian matrix has rank n at that critical point, and it is then called “nondegenerate”. Any C² function can be approximated by a Morse function. A function on a manifold is called a Morse function if none of the singularities are degenerate. Therefore, the critical points of a Morse function are isolated, so for a compact manifold, only a finite number of them exist.

4. Homotopy Types

Given a manifold and a Morse function on it and knowing the sequence of the indices of that function's singularities, Morse theory shows that a topological space with the same homotopy type as the manifold can be constructed as a cell complex after a sequence of operations corresponding to the singularities of the Morse function.

For any real number representing a height, the cell gives a model for the part of the manifold whose points are below that heights. As R is scanned from top to bottom, the topology of the complex does not change between two successive singular values, but each time a singular value is crossed, the cell complex is updated by attaching a k-cell to the former complex, where k is the index of the singularity. In brief, the shape of an object can be retrieved by attaching cells with the same dimensions as those of critical points.

FIG. 1 shows the relationship among indices of singularities, k-cells and an object to be coded by them. Here, the object is represented by a torus. As shown in FIG. 1, each time the threshold crosses critical heights, the topology of the set of points below the threshold changes. This change is topologically equivalent to attaching a k-cell. As shown in this Figure, 2-cell (k=2) , 1-cell (k=1) , and 0-cell (k=0) can be represented by shapes such as a bowl laid upside down, a string, and a single point, respectively. The shape of the original object can be retrieved by attaching those cells together to build a cell complex followed by transforming it as in clay works. For example, a torus can be built by attaching one 2-cell, two 1-cells, and one 0-cell.

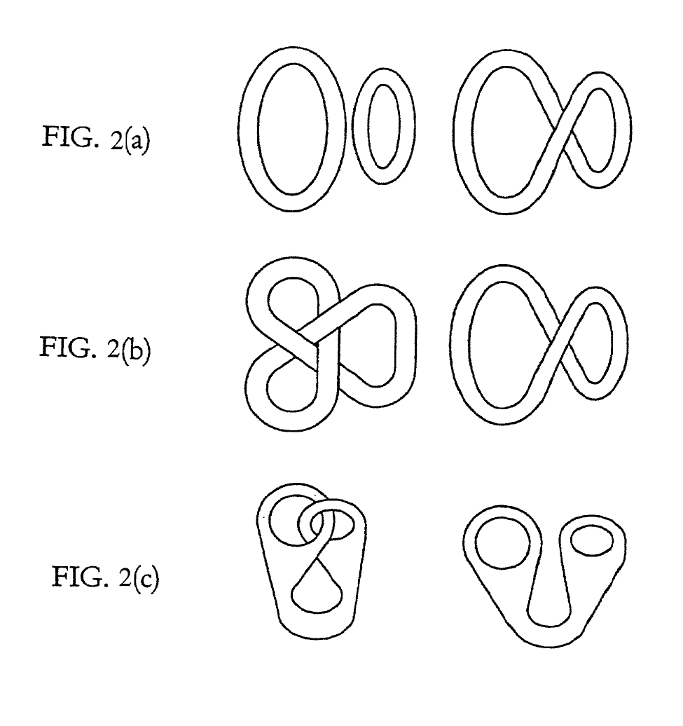

Note that the mere sequence of indices does not completely describe the cell complex. FIGS. 2a-2c show three pairs of surfaces with the same sequences of Morse indices, respectively. Thus, with the sequence of indices only, the cell complex cannot be completely determined. Therefore, one must know which connected components of the cross section will be involved in attaching each cell.

G. Reeb proposed that one can consider a graph obtained from the manifold as a topological quotient space. The Reeb graph is to represent the mutual relationship of singularities and is obtained by representing the object's surface with contour lines and the connected components of each coordinate with a single point. He did this by identifying in the manifold (assumed to be compact) all the points that have the same value under the Morse function and that are in the same connected component as being a corresponding cross section. That is, the connected components of the part of the manifold situated strictly between two critical levels are thus represented by separate line segments—the edges of the graph. Each singularity corresponds to a vertex of the graph. The Reeb graph can be said to be a graph representing the skeleton of an object.

FIGS. 3a-3c show the relationship between a torus and its Reeb graph. FIG. 3a shows an original torus, FIG. 3b its cross sections, and FIG. 3c its Reeb graph, respectively. Disjointed cross-sectional circles on the same plane in FIG. 3b correspond to the separate two edges in FIG. 3c.

(3) Limits of the Theory

Importantly, using Morse theory in this classical way permits only the recovery of the manifold's intrinsic topological properties. The sequence of indices does not code the way the manifold is embedded in space. For instance, you cannot determine whether an embedded torus is knotted in space, since both knotted and unknotted configurations can lead to the same singularities, as shown in FIG. 2b. The existence of links (shown in FIG. 2c) is another feature overlooked by simple Morse coding.

(4) Extending Morse Coding

This section is restricted to the case of surfaces associated with compact 2-manifolds of class C² that are C² embedded in 3D space. It is desirable that this Morse function on the surface is induced by a height function in space. In fact, it is actually sufficient to slightly rotate a C² surface to have singularities become nondegenerate, thereby enabling its height function to become Morse.

Morse theory also states that between two critical levels, that is, heights of the planes containing critical points, the topological type of the section does not change. Thus, a number of more or less bent cylinders can be used to model the surface between two such levels. Since nonsingular cross sections are made of circles embedded in a plane, the possible nested configuration call for hierarchical and structural coding—grouping plural circles that are contained in the same circle.

Besides information related to the Reeb graph, that is, on how vertices are connected to each other, a proposed extended coding also contains other information in addition to the Morse index—information about the way cylinders are exchanged and turn around each other between two successive critical values.

(5) Coding System Example

A prototype coding system example will next be explained. This coding system describes a surface by attaching a k-cell and tracking the changes in the hierarchical structure of contours on cross-sectional planes. Operators are introduced to describe the attachment of cells and code the surface. The iconic representation of cells attached by the operators enables easy understanding of the structure of the surface to be coded. The major advantage of this coding system is that the topological integrity is guaranteed by the resulting code.

1. Contours with Parent-Child Relations

The method for representing the hierarchical structure of contours will next be described. Here, a tree structure is used.

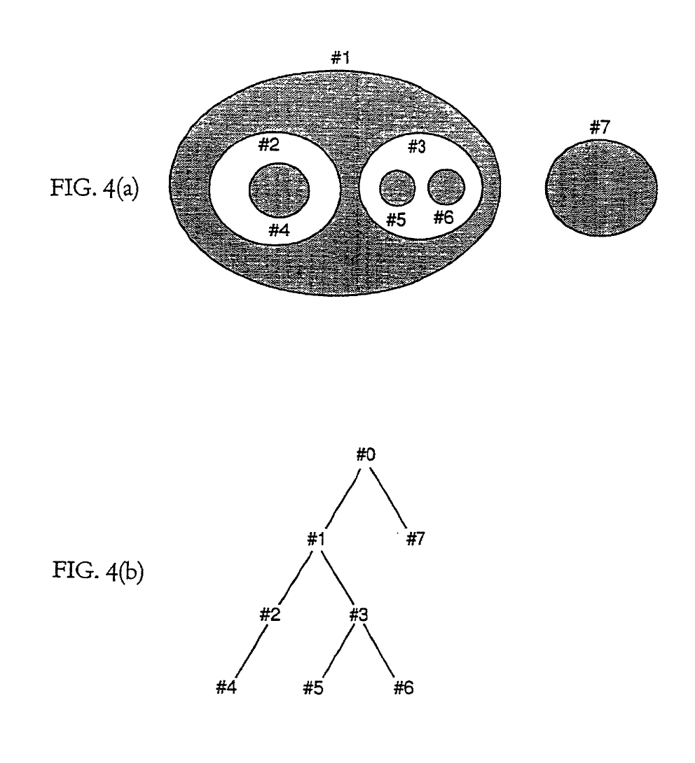

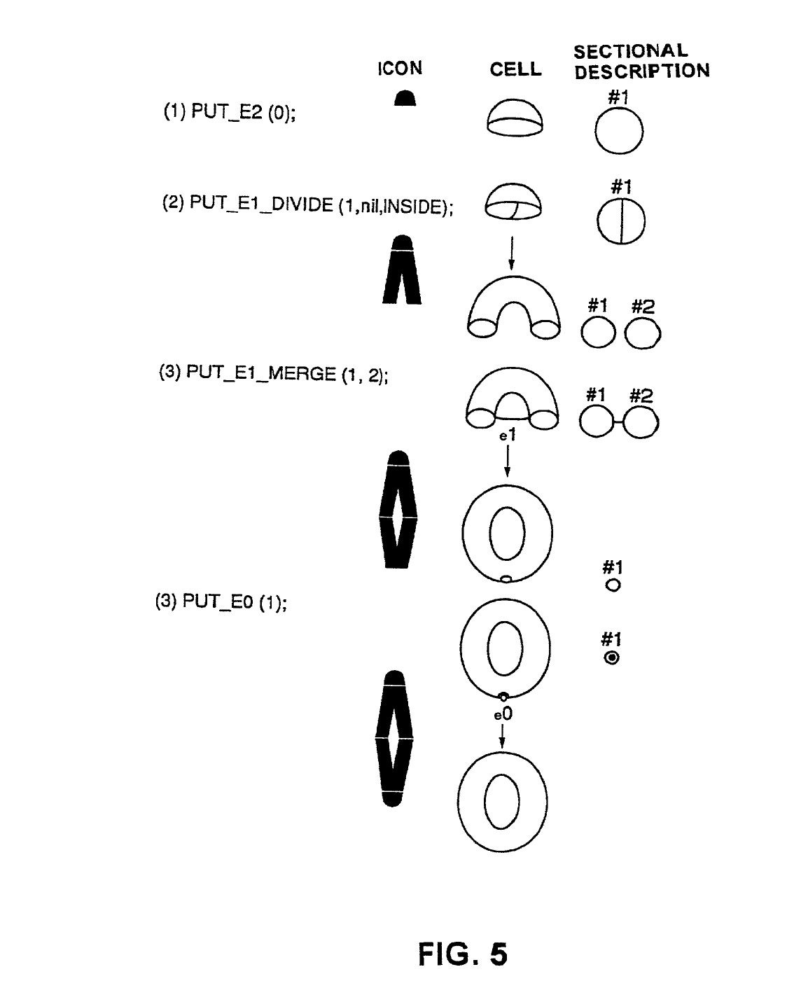

When a contour contains another contour, the former is called the parent contour of the latter and the latter is called the child contour of the former. FIGS. 4a and 4b show the parent-child relation of contours and its tree structure representation, respectively. The parent-child relation can be nested, as shown in FIG. 4a. In the following #N represents contour number N. For example, contour Number 1 is abbreviated #1. #1 is the parent contour of #2, which in turn is the parent contour of #4. For convenience, contours that have no parents, such as #1 and #7, are described as the child contours of “virtual contour #0”. Therefore, #0 comes to the top of the tree structure.

We define an array parent #[ ] to show the parent of the given contour. In the example above, parent#[1]=0. On the other hand, the child contours of a contour are listed in an array children [ ], to which a pointer is contained. For example, the pointer to the child contours of #3 is contained in children[3] and the child contours #5 and #6 are represented as

children[3]↑[1]=5 and children [3]↑[2]=6.

For convenience, contours having the same parent contours are called sibling contours. In FIG. 4a, #2 and #3 are sibling contours. The parent's parent contour is called the grandparent contour and the child's child contour is called grandchild contour. Also, a contour in whose interior the object exists is called a solid contour and a contour in whose interior the object does not exist is called a hollow contour. In FIG. 4a, #1, #4, #5, #6, and #7 are solid contours, while #2 and #3 are hollow contours.

2. Operators for Attaching Cells

There are four defined operators: Put_e0, Put_e1_merge, Put_e1_divide, and Put_e2. These paste the cells. In what follows, a k-cell is abbreviated to e^{k}.

Construction proceeds from the top to the bottom of an object. The process ends when it is no longer possible to attach cells. The contour structure on the cross-sectional planes is used to represent the status of the surface which the operators are constructing.

FIG. 5 shows methods for constructing a torus using these operators. In the following, functions of the operators will be described with reference to this Figure.

1. First, Put_e2 (0) is used to create a cell e² as shown at the top of FIG. 5. The parameter “0” in Put_e2 (0) means that #1 is created inside #0, which is the virtual contour. The cross section of this cell is shown under “Sectional Description” of FIG. 5. As shown in FIG. 5, Put_e2 has the function to create a contour on a cross-sectional plane. All the contours the operators create are numbered in the order in which they are created. The contour created by Put_e2 (0) is #1.

The status of a newly created contour is always “enabled” at first. This means that cells can be attached to the contour. We show our iconic representation of the cell e² under “Icon” in FIG. 5.

2. A cell e¹ is pasted to e² by Put_e1_divide (1, nil, inside). A newly created contour is numbered as #2. The third parameter “inside” indicates that #2 is created as the child contour of parent#[1]=0, which is the virtual contour. The second parameter is the list of child contours to be operated on. In this case, the second parameter is “nil”, which indicates that no operation is performed on child contour, consequently, no child contour is to be removed.

3. Another e¹ is pasted to merge #1 and #2 by Put_e1_merge (1, 2). This operator merges the two contours designated by the first and second parameters into the first. Since the contour indicated by the second parameter disappears by merging, the second contour is removed from the list of child contours of its parent contour. The status of the second contour is changed from “enabled” to “disabled”. Therefore, no cell can be attached to this contour.

4. Finally, Put_e0 (1) eliminates #1 by pasting e⁰. The status of #1 is changed from “enabled” to “disabled”. The icon reflects this change. Note that when a contour is attached to a cell e⁰ , all of its child contours, if any, have to be disabled beforehand.

The cell attaching procedure ends here because no enabled contours remain.

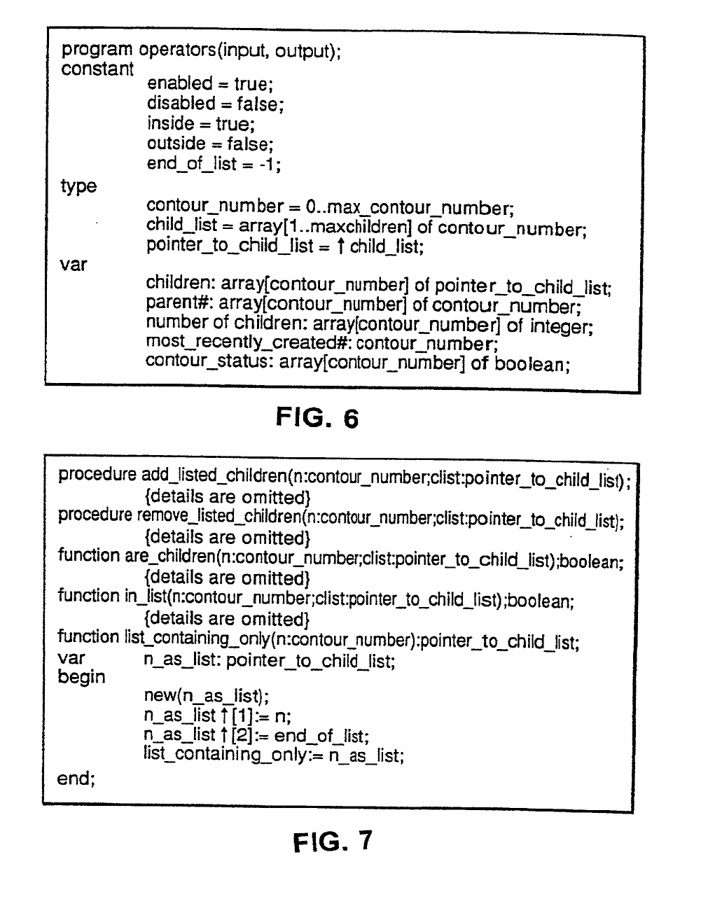

FIGS. 6-8 show examples of operator programs in pseudo-Pascal code. Max_children and Max_contour_number are defined here as sufficiently large positive integers. They are used only for memory allocation purposes.

In FIG. 6, Number_of_children shows the number of child contours for each contour. Most_recently_created# shows the most recently created contour number. Contour_status shows whether each contour is enabled or disabled. Children gives the pointer to the array Child_list that contains the list of the child contours of a given contour. The end of Child_list is shown by the constant End_of_list. These variables are initialized as follows:

most_recently_created#:=0;

for i:=0 to max_contour_number do

number_of_children[i]:=0;

for i:=1 to max_contour_number do

contour_status[i]:=disabled;

contour_status[0]:=enabled;

Thus, the virtual contour here becomes enabled. Next, create_new_contour creates a new contour, increases most recently_created#, and initializes its status.

Procedure create_new_contour;
begin

most_recently_created#:=most_recently_created#+1;
contour_status[most_recently_created#]:=enabled;

end

In FIG. 7, we define two procedures and three functions for later use. add_listed_children adds the contours listed in the second parameter, clist, to the list of the child contours (children[n]↑) of the first parameter. remove_listed_children removes the contours listed in the second parameter, clist, from the list of the child contours (children[n]↑) of the first parameter. These two procedures also update the array Number_of_children and Parent#.

On the other hand, the function are_children (n, clist) returns “true” when all the contours in clist are child contours of #n. Otherwise it returns “false”. The function in_list (n, clist) returns “true” when clist includes #n. Otherwise it returns “false”. The function list_containing_only (n) is defined to make a list containing only one contour to be fed to the procedures add_listed_children and remove listed children.

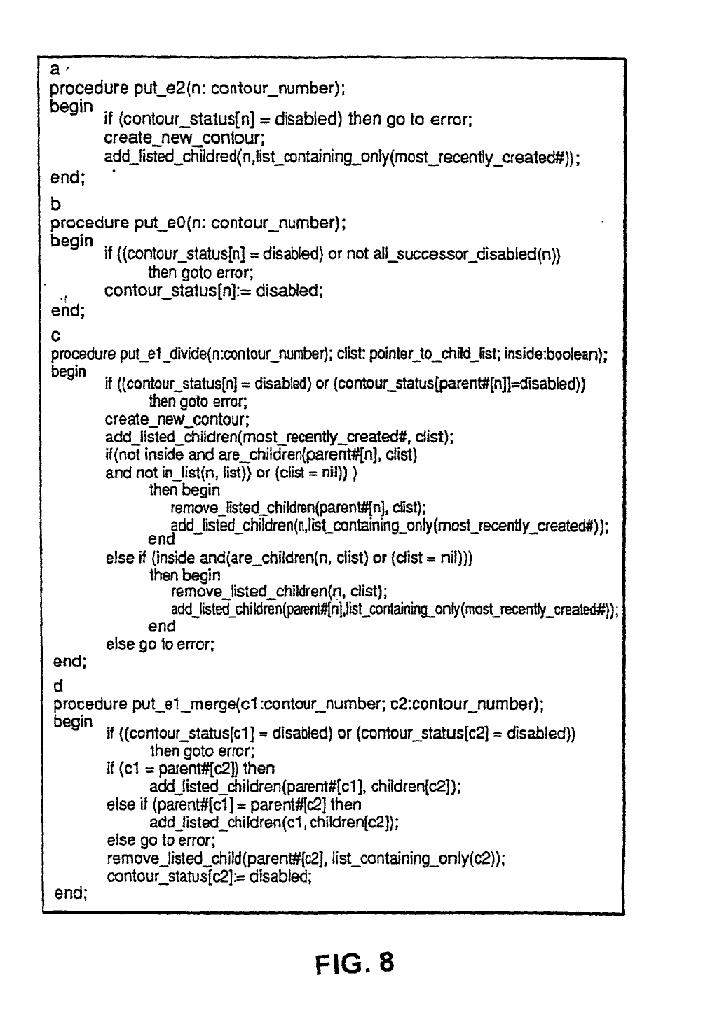

The four operators Put_e2, Put_e0, Put_e1_divide, and Put_e1_merge can now be defined. They are shown in FIG. 8.

1. Put_e2 (n) creates a new contour as the child contour of #n.

2. Put_e0 (n) eliminates #n by attaching e⁰. Here, All_successors_disabled (n) returns “true” if and only if all the successors of #n are disabled.

3. Put_e1_divide (n, clist, inside) divides #n to create a new contour. The contours listed in clist become the child contours of the newly created contour. They are removed from the list of the child contours of #r where either #r=#n or #r=parent#[n] holds. (This depends on whether they have been the child contours of #n or parent#[n].) Only these two cases are permitted.

4. Put_e1_merge (c1, c2) merges #c2 into #c1. #c2 is removed from the list of child contours of parent#[C2]. All the child contours of #c2 become the child contours of parent#[c1] or #c1, depending on whether #c1 is the parent or the sibling contour of #c2. Only these two cases are permitted.

To easily understand the structure of the surface being coded by these operators, we propose a graphic representation of the cells that constitute the Reeb graph of the surface.

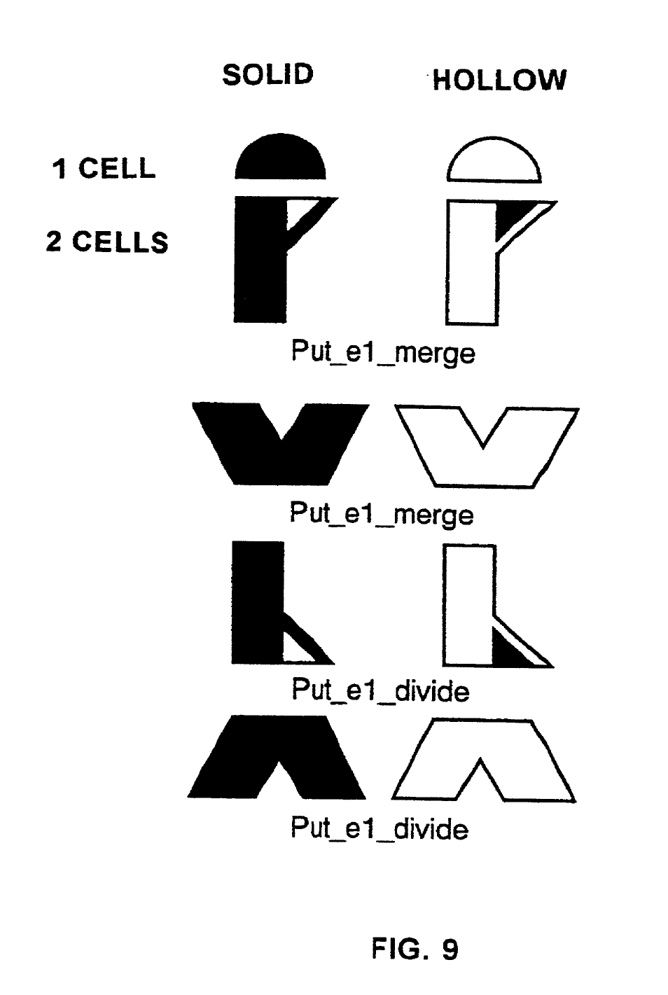

The icons depicted in FIG. 9 represent cells. We paste two cells by letting the flat top and the flat bottom of the two coincide. We depict the cells for hollow contours with white icons and cells for solid contours with black icons. For e¹, plural types of icons exist.

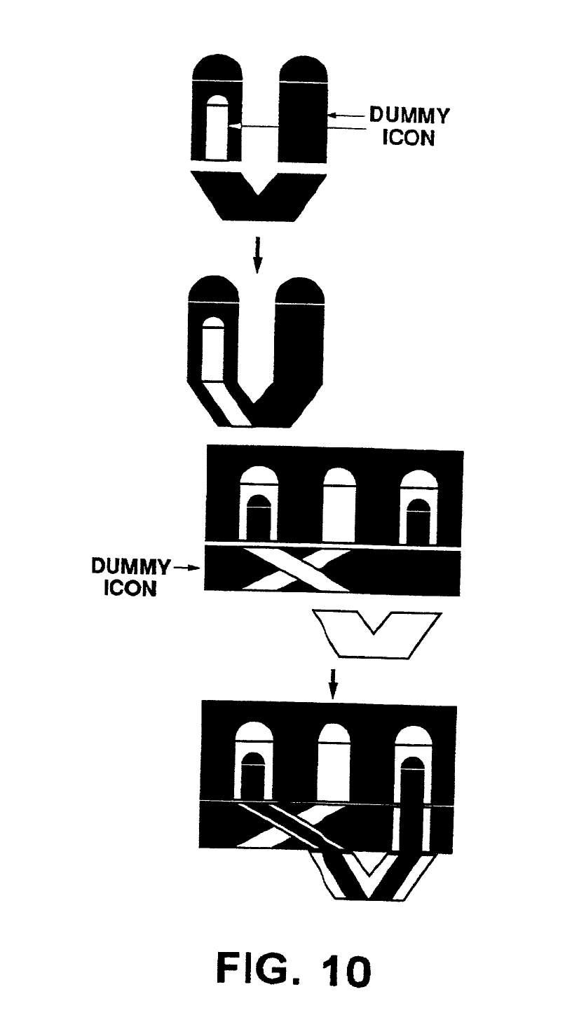

FIG. 10 shows the attachment of cells. The icons of child contours are drawn inside of the icons of their parent contours, as shown in this Figure. Mirror images of the icons on the vertical axis are also allowed.

Icons are characteristic in that they preserve the contour structure to which they are attached. For example, when e¹ is attached to the cells as shown in the top half of FIG. 10, the icon preserves the structure of the parent-child relation of the cells to which it is attached.

Dummy icons are inserted where necessary to adjust the height of cells, as shown in the bottom half of FIG. 10. Because the Reeb graph may not be a planar graph, we can use the dummy icons to interchange the cells so that e¹ can be attached to the adjacent cells. e¹ interchanges the cells together with its inner structure. To preserve the hierarchical contour structure, the dummy icons cannot exceed the bounds of the parent contour of the contour to which it is attached or intrude into other contours. For this reason, only sibling contours can be interchanged using dummy icons.

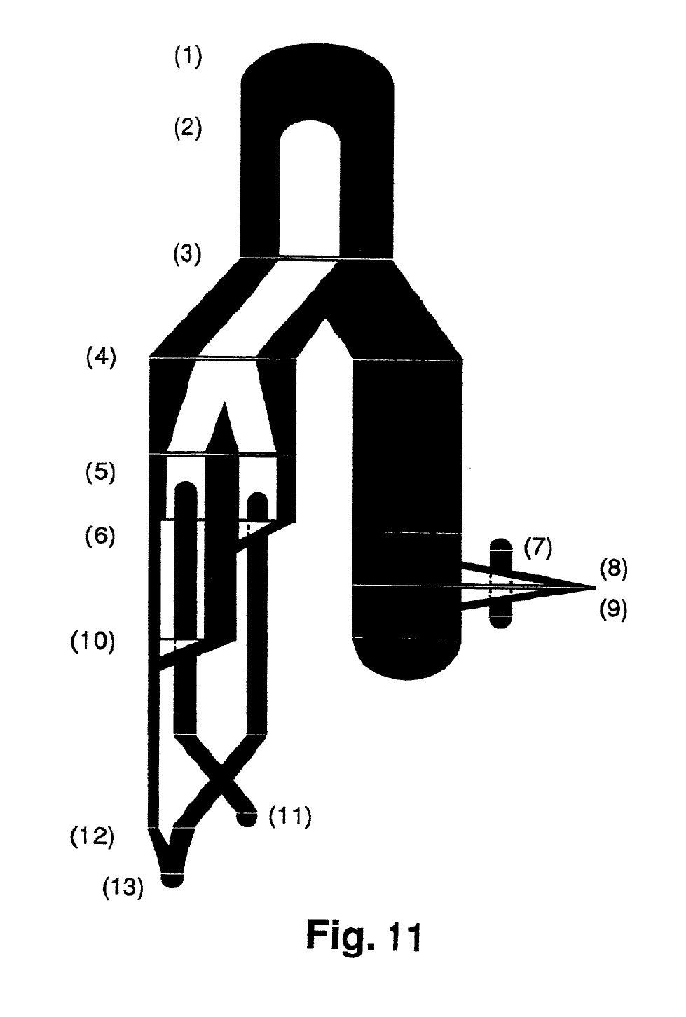

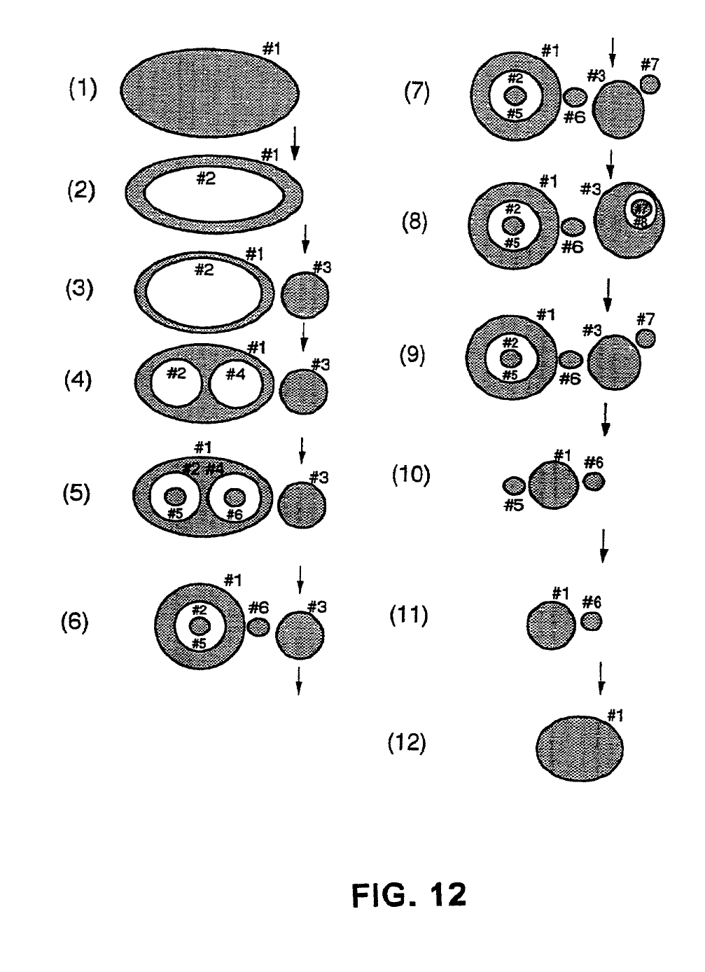

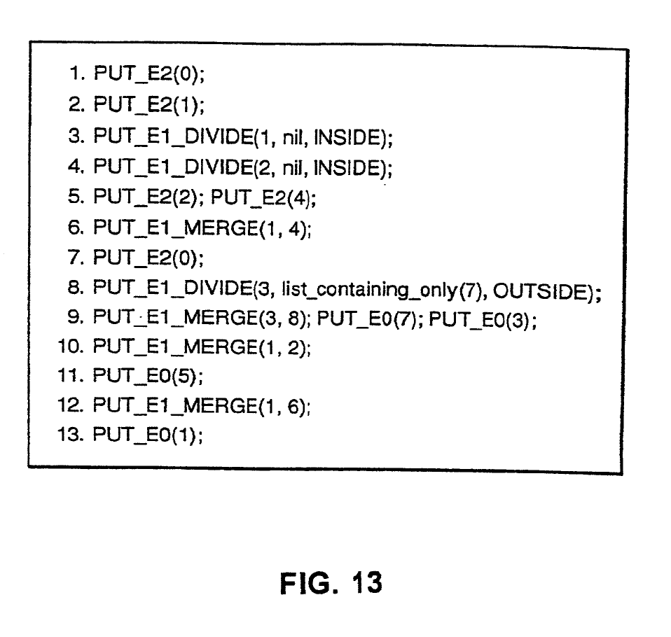

In summary, FIGS. 11-13 illustrate an example of the code for constructing an object using the operators. FIG. 11 shows an example of the Reeb graph of an object using icons. FIGS. 12(1) , 12(2) , 12(3) , 12(4) , 12(5) , 12(6) , 12(7) , 12(8) , 12(9) , 12(10) , 12(11) , and 12(12) are the corresponding cross-sectional contours, and FIG. 13 shows the operators for constructing the object.

[2] Surface Construction from Codes Using Operators

(1) Surface Generation as a Locus of Homotopy

In this section, surface is constructed from codes obtained by the previous method.

As was previously stated, the topology of a contour does not change between critical sections. When scanned from top to bottom, the shape of a contour changes. This transformation of a contour can be best represented by the notion of a homotopy. A homotopy transforms one function to another. In what follows, all the contours are to be represented by shape functions and the transformation are described by means of homotopies. The definition of homotopy is as given below.

Definition: Let f, g : X→Y be maps where X and Y are topological spaces. Then “f is homotopic to g” if there exists a map F: X x I→Y such that

F(x,0)f(x)

and

F(x,1)=g(x) for all points x ∈X.

Here I=[0,1]∈R. This map F is called “a homotopy from f to g” . When F is defined by

F(x,t)=(1−t)f(x)+tg(x) ,

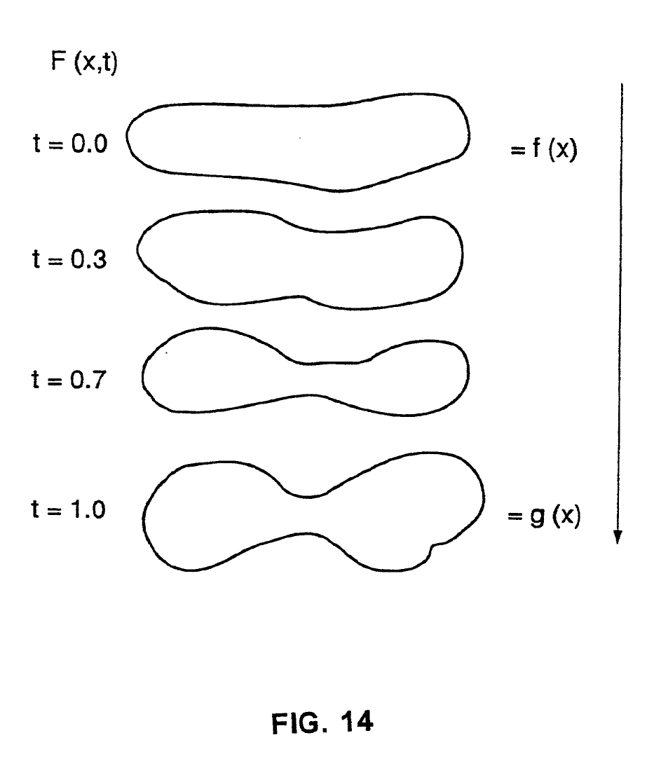

it is called a straight-line homotopy. In FIG. 14, homotopic transformation of contours is shown. In this Figure, the upper contour is represented by the shape function f and the lower by 9. The surface generated is the locus of the homotopy F from f to 9.

(2) Elements for Implementing Operators

The operations that generate a surface as shown in FIG. 14 are described as transforming the contours by homotopies.

1. Elements of the Operators

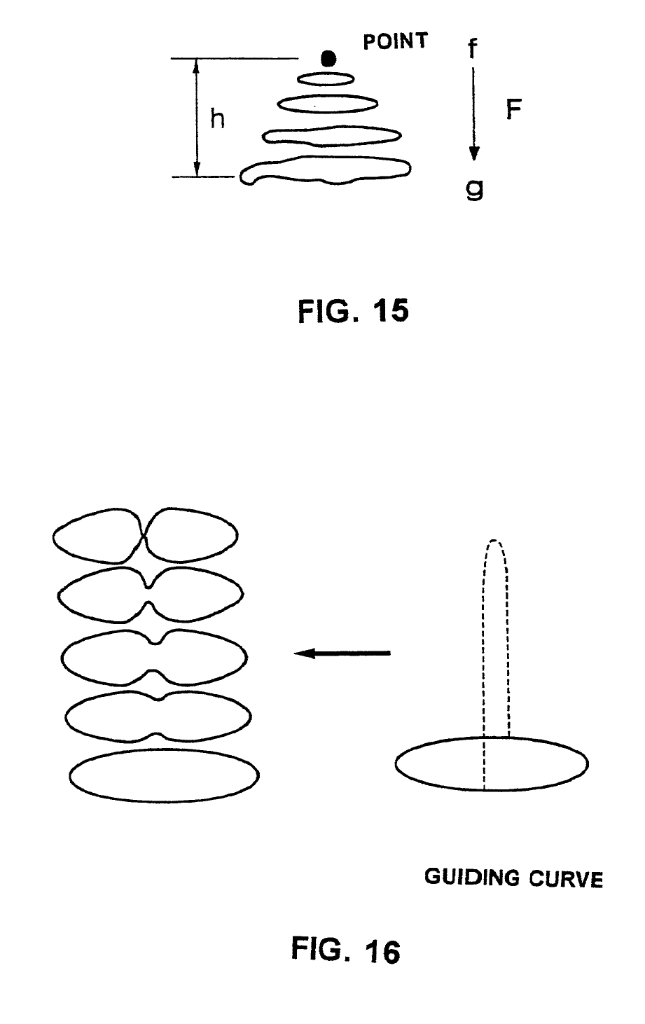

The following four main elements of the operators are described in FIG. 15.

(i) f: I→R³ gives the shape of the upper contour

(ii) g: I→R³ gives the shape of the lower contour

(iii) F: the homotopy from f to g

(iv) h: the difference in height between the two contours

2. Shape Functions

The following shape functions f and g are provided.

(i) point: a constant function that always gives the location of a fixed point

(ii) circle: gives the shape of a circle

(iii) polygon: gives the shape of a polygon that connects the given vertices

(iv) Bézier: An n-dimensional Bézier curve is written as

$$f ( u ) = {\sum }_{i = 0}^{n} {B}_{i}^{n} ( u ) {P}_{i} ( 0 \leq t \leq 1 )$$

and specified by an ordered set of n points called the control points Pᵢ∈R³. The control point can be modified by users. Here, Bⁿᵢ(t) is a Bernstein basis function defined by

$${B}_{i}^{n} ( u ) = ( \begin{matrix}n \\ i\end{matrix} ) {{u}^{i} ( 1 - u )}^{n - i} .$$

(v) NURBS (Non Uniform Rational B-Spline) curves: The control points of NURBS curves are also defined by users. A NURBS curve is defined by

$$f ( u ) = \frac{{\sum }_{i = 0}^{n} {N}_{i , k} ( u ) {w}_{i} {P}_{i}}{{\sum }_{i = 0}^{n} {N}_{i , k} ( u ) {w}_{i}}$$

where wᵢ is a weight associated with each control point. N_{i,k}(t) is a piecewise polynomial of degree (k−1) called a B-spline basis function and defined as

$${N}_{i , 0} = \{ \begin{matrix} 1 ( {x}_{i} \leq u < {x}_{i + 1} ) \\ 0 otherwise\end{matrix} \\ {N}_{i , k} ( u ) = \frac{( u - {x}_{i} ) {N}_{i , k - 1} ( u )}{{x}_{i + k} - {x}_{i}} + \frac{( {x}_{i + k + 1} - u ) {N}_{i + 1 , k - 1} ( u )}{{x}_{i + k + 1} - {x}_{i + 1}} ( 2 \leq k \leq n + 1 ) .$$

NURBS is extensively used in a great number of CAD systems. It can represent a quadric surface accurately and has a local approximation property, that is, if a control point or the weight associated with it is changed, it affects the shape of the surface only in its neighborhood.

3. Homotopy F

As the homotopy F, functions are provided as follows. They output cross sectional contours.

(i) linear: a straight-line homotopy

(ii) quadrant:

F(x,t)=quadrant(x,t)=\sqrt{1−t²}f(x)+(1−\sqrt{1−t ²})g(x)

(iii) parabola: F(x, t)=(1−t²)f(x)+t²g(x)

(iv) cardinal spline: A cardinal spline interpolates the upper and lower contours. Parameterization can be done automatically using a toroidal graph that indicates the correspondence between the contours.

(v) guiding curve: A contour is transformed by moving a point of the contour along a guiding curve. More than one guiding curve can be attached to a contour. When a contour is represented by a Bézier or NURBS curve, the guiding curves may be attached to the control points and the transformation may be determined by the movement of the control points. The movement of a control point where a guiding curve is not attached can be computed using the guiding curves of its adjacent control points.

FIG. 16 shows the gradual transformation of the upper contour to the lower one by attaching a guiding curve to a contour by users.

In any case, surface patches are generated among the resulting contours using the cardinal spline.

4. Shape Functions of Contours for the Operators

The shape functions of contours for the operators are given in the following.

(i) Put_e2

f: point

g: specified by users (default: circle)

F: specified by users (default: quadrant)

(ii) Put_e0

f: the shape function of the contour to which the e⁰ is attached

g: point

F: specified by users (default: quadrant)

(iii) Put_e1_divide and Put_e1_merge

For Put_e1_divide and Put_e1_merge, the path c of e¹: [0, 1]→R³ of e¹ must be determined. In the implementation, the path c is specified by the locations of c(0) , c(½) and c(1). The path has to be smooth and its tangent vector at c(½) has to be parallel to the xy-plane so that c(½) becomes the saddle point of the generated surface. The default location of c(½) is at

$$c ( 1 / 2 ) = ( \begin{matrix}\frac{{c ( 0 )}_{x} + {c ( 1 )}_{x}}{2} \\ \frac{{c ( 0 )}_{y} + {c ( 1 )}_{y}}{2} \\ {c ( 0 )}_{z} - h\end{matrix} ) where$$

$$c ( t ) = ( \begin{matrix}{c ( t )}_{x} \\ {c ( t )}_{y} \\ {c ( t )}_{z}\end{matrix} ) .$$

The default path is an arc of an ellipse connecting c(0) and c(1) given by

$$c ( t ) = ( \begin{matrix}( 1 - \sqrt{1 - {( 2 t )}^{2}} ) {c ( 0 )}_{x} + \sqrt{1 - {( 2 t )}^{2}} {c ( 1 / 2 )}_{x} \\ ( 1 - \sqrt{1 - {( 2 t )}^{2}} ) {c ( 0 )}_{y} + \sqrt{1 - {( 2 t )}^{2}} {c ( 1 / 2 )}_{y} \\ ( 1 - 2 t ) {c ( 0 )}_{z} + 2 t {c ( 1 / 2 )}_{z}\end{matrix} )$$

for 0≦t≦½ and

$$c ( t ) = ( \begin{matrix}( 1 - \sqrt{1 - {( 2 - 2 t )}^{2}} ) {c ( 1 / 2 )}_{x} + \sqrt{1 - {( 2 - 2 t )}^{2}} {c ( 1 )}_{x} \\ ( 1 - \sqrt{1 - {( 2 - 2 t )}^{2}} ) {c ( 1 / 2 )}_{y} + \sqrt{1 - {( 2 - 2 t )}^{2}} {c ( 1 )}_{y} \\ ( 2 - 2 t ) {c ( 1 / 2 )}_{z} + ( 2 t - 1 ) {c ( 1 )}_{z}\end{matrix} )$$

for ½≦t≦1. The projection of the default path to the xy-place is the line segment connecting c(0) and c(1). A parabolic path can easily be provided by substituting (1−x²) for (1−x²)^{½}. The elements for Put_e1_divide and Put_e1_merge are as follows.

Put_e1_divide

f: the shape function of the contour to which e¹ is attached

c: the path of e¹

c(0) and c(1): specified by s₁ and s₂∈[0, 1] where c(0)=f(s₁) and c(1)=f(s₂) respectively

g₁ and g₂: obtained by dividing the contour along c

Put_e1_merge

c: the path of e¹

f₁ and f₂: the shape functions of the contours to which e¹is attached

c(0) and c(1): specified by s₁ and s² ∈=[0, 1] where c(0)=f₁(s₁) and c(1)=f₂ (s₂) respectively

g: obtained by merging the contours along c

The transformation for Put_e1_divide is performed by transforming the contour using the path of e¹ as the guiding curve; i.e.,

F(s₁, t)=c(t/2)

and

F(s₂, t)=c(1−t/2)

On the other hand, the transformation for Put_e1_merge is obtained as

F₁(s₁, t)=c(t/2)

and

F₂(s₂, t)=c(1−t/2)

Embodiments

The preferred embodiments of the present invention will next be described in view of the aforementioned base techniques.

Regarding the base technique [1], the Morse theory, which provides information concerning singular points and indices only, can show conceptually the type of cells constituting a solid. According to Morse theory, the 3D shape of an object can be conceptually reconstructed from basic singular point information, that is, singular points, their indices, and the sequence of the singular points. However, Morse theory fails to present a geometrical relationship in which those cells are to be connected to one another.

The Reeb graph helps to resolve this problem of Morse theory. The Reeb graph shows the connection between the cells and can provide information regarding the connectivity relationship between the singular points, which are represented by nodes of the graph. Thus, by combining Morse theory with the Reeb graph, the 3D shape of an object can be recognized in a more detailed manner. In a particular example, existing polygon data representing the shape of the object can be obtained, information relating to singular points of the Morse function can be extracted, and then information relating to the connection between the singular points can be obtained. In principle, the shape of the object can then be understood based on the above extracted and obtained information.

Next, it is understood that only the structure or the framework of the object can be reconstructed using Morse theory and the Reeb graph. Namely, only overall topological information can be obtained. Therefore, additional geometrical information may be necessary to understand the more precise geometrical shape of the object. For this reason, contour information may also be obtained.

A significant difference between the base techniques and the present embodiment is the Morse function adopted. The base techniques utilize a height function as the Morse function, which returns the value of the z-axis coordinate. On the other hand, the present embodiment adopts a graph distance as the Morse function. This function returns the number of polygon edges on the shortest path that reaches a vertex under consideration from a base vertex that is defined on the original polygon object. A Reeb graph can also be determined for this Morse function and can be generated automatically.

In the base techniques, when a solid is encoded using the techniques in section [1], a surface can be created for it using the techniques in section [2]. In general, section [1] utilizes the concept of homotopy type, while section [2] utilizes the concept of a homotopy function.

According to the techniques in sections [1] and [2], homotopic connection between respective critical sections can be used to re-create the surface of the solid. This is because the topology remains the same between critical sections, and a homotopic connection keeps the topology unchanged. In other words, the critical sections are the sections of the necessary and sufficient number of divisions so that the surface of the object can be re-created by a continuous function like the homotopy function.

A critical section corresponds to a node of the Reeb graph and the space between the critical sections corresponds to an edge of the graph. The nodes corresponding to cells e² and e⁰ are topologically two-dimensional cells that are equivalent to a two-dimensional open disc. Note that the cells e² and e⁰ are singular points that are not degenerate in the base techniques, but in the embodiment a singular surface may be degenerate. However such degeneration can be avoided by providing an offset onto the singular surface.

A real object contains a surface, which is topologically equivalent to a cylinder, around each edge of the Reeb graph. Each of the edge topologically corresponds to an annulus, which is a name for a cylinder in topology. Therefore the Reeb graph of the object is obtained, and thereby the object will be decomposed into components including two-dimensional cells and annuli in the embodiment. Once a base vertex is defined on the object, the Reeb graph is uniquely determined. Therefore any object can be decomposed into the components constantly and automatically. This is the merit obtained when the base techniques are utilized. As described later, since the two-dimensional cells and annuli are all in the shape of triangle strips, they can be encoded easily.

In the embodiment, an object encoding is divided into two stages: encoding connection between polygon vertices and encoding geometrical information of the polygon vertices. This is because the base techniques aim at the generation of a smooth surface of the object, while the embodiment aims at the compression of the polygon data. A graph distance is adopted as the Morse function because it can be highly compatibly applied to the polygon data.

First, a general concept used in the embodiment is explained and procedures of the embodiment are summarized.

Shape Components

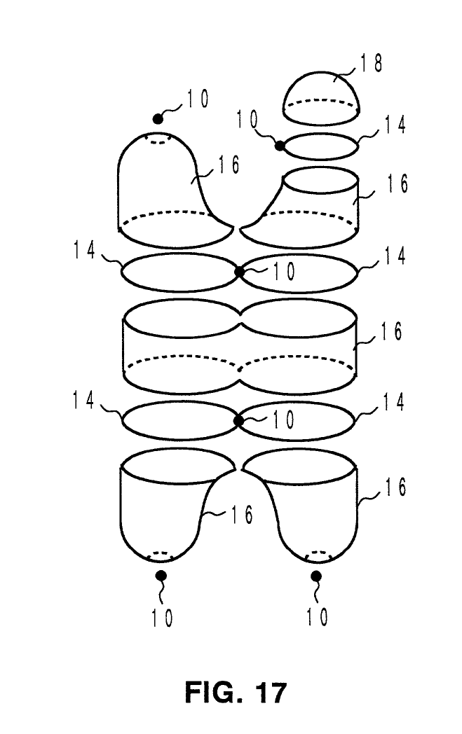

FIG. 17 illustrates shape components in the embodiment. FIG. 17 shows a three-dimensional object having an “H” shape.

A contour of a cross-section on a closed surface M is defined as a connected isovalue line when a continuous function f: M→R is defined on the surface. In the embodiment, a graph distance from a base vertex is used as the function f. The first shape component is a contour represented as a graph structure called the c-graph. A c-graph is composed by sets of nodes and edges, denoted as c-nodes 10 and c-edges 14, respectively. The vertices on a single c-graph have the same graph distance from the base vertex. Note that the graph distance is converted into a height direction in FIG. 17 for ease of understanding.

A c-graph can be composed by only a single c-node 10. In this case, c-node 10 is a peak or a pit that is a singular point of the Morse function f. If a c-graph is in a loop shape, a single c-node 10 can be provided on the loop for the sake of convenience and it is considered that there exists a c-edge 14 having the c-node 10 as an endpoint. Namely, if a c-graph is a loop, the c-graph has one c-node 10 and one c-edge 14 in principle.

If a c-graph is in an “8” shape, there exists one c-node 10 at its cross point, which is a saddle singular point. Each of the two loops of the c-graph is a c-edge 14.

In the embodiment can ensure validity as an orientable closed surface can also be ensured. The Euler equation is satisfied in the same way as for a boundary representation:

#(c-node)−#(c-edge)+#(2-cell)=2−2 g

where # denotes the number of elements, and g is the genus of the closed surface. In the case of FIG. 17, the above equation is 6−5+1=2−0. Thus, the encoding apparatus of the embodiment ensures that an object is a closed surface and its encoding is valid by using this equation.

Other shape components are an annulus 16 and a 2-cell 18. An annulus has two different c-graphs or parts thereof as its boundaries, and it is topologically equivalent to a cylinder. A 2-cell has only one boundary composed of a c-graph or part thereof, and is equivalent to an open disc topologically.

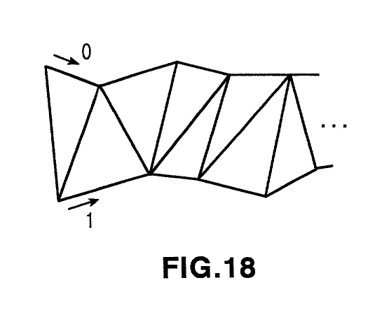

The 2-cell and the annulus are extracted from the triangle mesh of an original object based on a graph distance so that they can take a form of a triangle strip as described later. A triangle strip is defined as a linear triangle stream stretching in one direction in which connectivity can be represented as a bit stream as shown in FIG. 18. This bit stream is called a marching pattern. In the Figure, the marching pattern is “01001011”.

The graph distance is defined for each vertex. The graph distance for a vertex represents the number of edges that compose a shortest path to the vertex from a base vertex and is calculated using Dijkstra's algorithm. Here, it is important to note that the difference between a graph distance value for a vertex and that for an adjacent vertex must be zero or one. That is, this graph distance function is a continuous function of a positive integer on a surface, and can therefore be applied to the homotopy model.

The fundamental shape components have been explained so far. In the embodiment, an open annulus is also defined in order to handle an open mesh. An open mesh is a mesh that has an open edge, that is, an edge at which a triangle exists on only one side of the edge. In order to allow for this situation, the open annulus takes the form of an acyclic triangle strip, and its initial and terminal edges correspond to the open edges. This can be compared to the ordinary annulus described above, circular annulus, in which the triangle strip is circular. Although an open annulus is topologically equivalent to a disc, the boundaries consist of two different c-graphs (or parts thereof) as well as a circular annulus. Whether an annulus is circular or open can be determined by traversing the triangles in the annulus in one direction from a starting triangle. If the traversing returns to the starting triangle, the annulus is circular, otherwise open. Note that the open annulus is effective for encoding a non-manifold.

Constructing Shape Components

The first step in extracting the shape components is the classification of each of the triangles, edges, and vertices in a triangle mesh. A triangle in a mesh may be included on a 2-cell or on an annulus. If the three vertices of the triangle have the same graph distance value, the triangle is on a 2-cell, otherwise it is on an annulus.

An edge may belong to any of three components; it may be an edge on a c-graph, an edge on a 2-cell, or an edge on an annulus. An edge is classified using the following steps:

Step 1. If the graph distance values of the end vertices of the edge are different, it is on an annulus, otherwise go to step 2.

Step 2. If there is an edge of an annulus among the four adjacent winged edges, it is on a c-graph, otherwise go to step 3.

Step 3. If at least one triangle among the triangles adjacent to the edge has two edges that are already classified as on a 2-cell, it is on a c-graph, otherwise it is on a 2-cell.

A vertex in a mesh corresponds to either a c-node or a vertex on a c-edge. The vertex is classified according to the attributes of the adjacent edges of the vertex. If the number of c-edges incident to the vertex is two, the vertex is on a c-edge, otherwise it corresponds to a c-node.

Step 3 is a necessary condition for a 2-cell to be in a triangle strip shape. If the existing three edges of a triangle were all on a 2-cell, the 2-cell could be branched out at the triangle and it could not be a triangle strip.

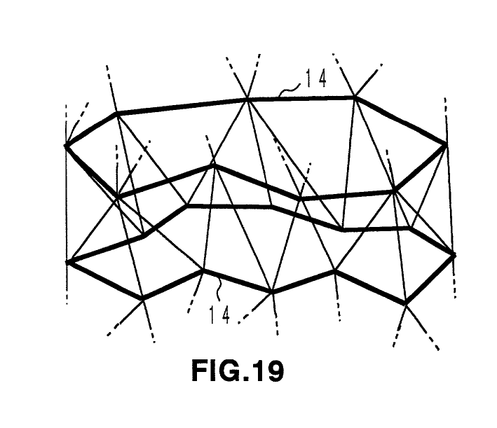

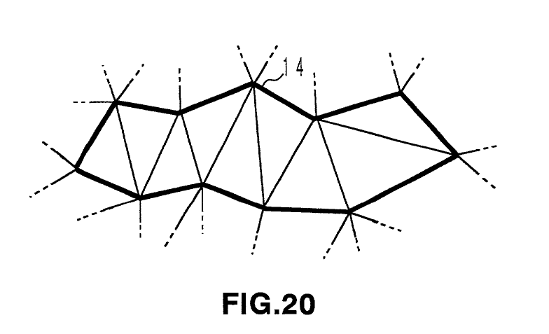

Once the elements of the mesh are classified, the annuli, 2-cells, and c-graphs are constructed by grouping the classified triangles, edges and vertices. Thus, edges on a c-graph that are connected compose one c-graph, a triangle and its adjacent triangle on an annulus are integrated into one annulus if they share a common c-edge on an annulus, and so on. The annuli and 2-cells always take the form of triangle strips when constructed in this manner as shown in FIG. 19 and FIG. 20.

The c-graphs can be decomposed to c-nodes and c-edges by using the classification of vertices and edges described above.

The embodiment compresses the topology of a mesh based on a continuous function of the graph distance and the particular function used sometimes has a great influence on the compression ratio. The function depends on which vertices of the polygon mesh are chosen as the base vertices. The base vertices may be specified by a user or may be set automatically. Such automatic setting can utilize geometrical information. For instance, the vertex whose z-axis value is the maximum or a cusp of the polygon mesh may be automatically set. Global topological information may be also used. For instance, the vertex where a branch occurs may be set as a base vertex. In any cases the graph distance value on the base vertex is zero.

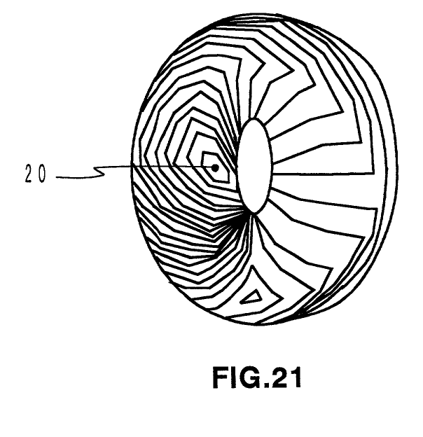

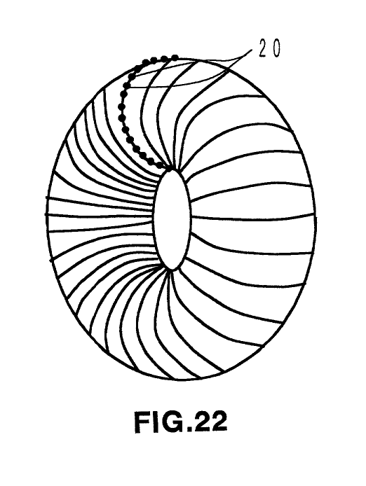

FIG. 21 shows the shape components constructed when one base vertex 20 is specified. FIG. 22 shows the shape components constructed when several base vertices 20 are specified. In both cases a torus is used as the object.

In FIGS. 21 and 22 the black lines are c-graphs. In this example, the method used for FIG. 22 provides twenty percent higher compression than that for FIG. 21. This improvement is because the selection of a continuous function suitable for the structure of the polygon mesh improves a prediction procedure for geometry compression that is described later.

Lossless Connectivity Compression

The member variables of each shape component are now compressed by Huffman coding and the marching pattern of the triangle strip, that is, the connectivity information of the polygon mesh are encoded as a bit stream. In the case of this compression method, the original marching pattern can be completely reconstructed by a decoding process and therefore a lossless compression can be realized.

Touma et al. propose another lossless connectivity compression method in a paper “Triangle Mesh Compression”, Graphics Interface '98 Proceedings, pp.26-34, 1998. The proposed encoding method is to describe the total number of other vertices connected with one vertex in a predefined order.

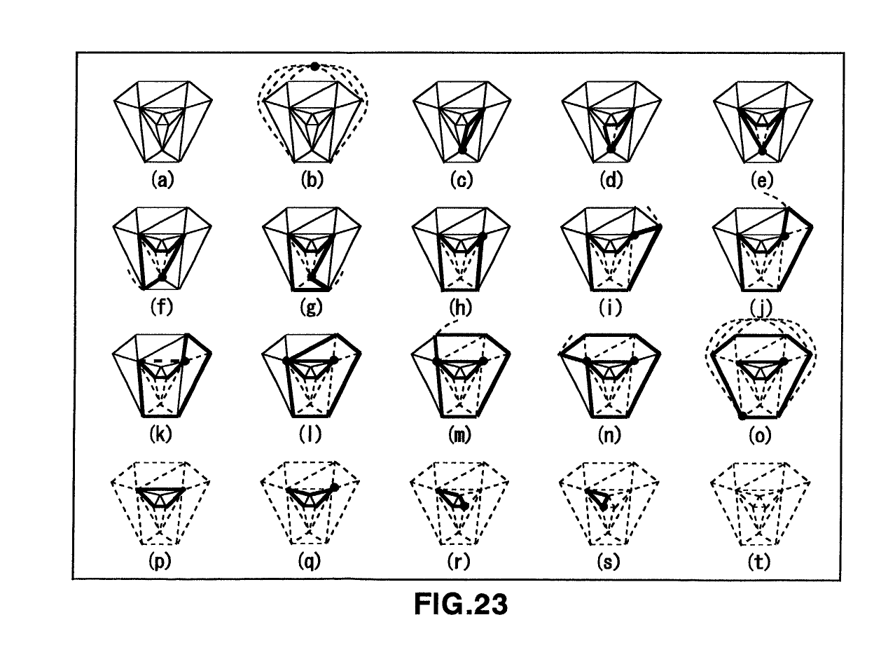

FIGS. 23(a) to (t) show the procedure of Touma's encoding method. In these Figures, the bold lines are called an active list. The active list partitions the mesh into an “outer” part containing edges not yet encoded, and an “inner” part containing edges already encoded. The broken lines indicate edges already encoded.

In this method, a polygon mesh is first input (FIG. 23(a)). Next, a dummy vertex is added and connected to all boundary vertices (FIG. 23(b)). This is because Touma's method assumes a closed surface. Next an initial triangle is selected, and a focus vertex, sometimes simply referred to as a focus, is marked (FIG. 23(c)). Since the number of vertices connected with this focus is six, a code word “add 6” is generated. With the focus unmoved, a next vertex is considered in counter-clockwise order and a code word “add 7” is generated. Likewise “add 4” is generated for the last vertex in the selected triangle.

Next, the active list is expanded in counter-clockwise order around the focus (FIG. 23(d)). A code word “add 4” is generated for a newly added vertex in the expanded active list. Likewise, “add 8” (FIG. 23(e)) , “add 5” (FIG. 23(f)) , and “add 5” (FIG. 23(g)) are generated. All the edges are now encoded for this focus.

The focus is moved on along the active list in counter-clockwise order (FIG. 23(h)) , “add 4” (FIG. 23(i)) and “add 5” (FIG. 23(j)) are generated. Since the next free edge of the focus leads to a vertex already in the active list, the active list is split into two separate active lists (FIG. 23(k)). A code word “split 5” is now generated. Here “split” indicates the split of the active list, and “5” is an offset indicating the number of the unencoded edges along the active list in clockwise order around the focus. The smaller one of the separate active lists is pushed on the stack for future treatment, and the encoding procedure proceeds with the second one. The focus is moved on (FIG. 23(l)) , and “add 4” (FIG. 23(m)) and “add 4” (FIG. 23(n)) are generated. The encoding procedure is completed for the focus. Next, the dummy vertex is considered and “add dummy 6” is generated (FIG. 23(o)). The larger active list is completed for encoding and the smaller active list is popped from the stack (FIG. 23(p)). For a new vertex in the active list, “add 4” is generated (FIG. 23(q)). At this point all the edges are encoded. The focus is moved on (FIG. 23(r) , 23(s)) , and then the smaller active list is completed for encoding (FIG. 23(t)). The resulting code is “add 6, add 7, add 4, add 4, add 8, add 5, add 5, add 4, add 5, split 5, add 4, add 4, add dummy 6, add 4”.

In the embodiment, Touma's encoding method may be applied to each triangle strip. However, Touma's method cannot deal with a non-manifold. Another representation method according to the present invention may be used for encoding a non-manifold. A non-manifold means an open surface, for instance when a single edge of the polygon mesh is shared by three triangles.

The method of the present invention represents the number of triangles around a vertex. A basic representation looks like “3 (2, 4, 3)”. This representation indicates that there are three sets of triangles around the vertex and these sets are composed of two triangles, four triangles, and three triangles respectively. In the case of a manifold, there is only one set of triangles around a vertex and the generated code is simply “add 6” or the like in Touma's method. On the other hand, the representation of the present invention allows a non-manifold to be encoded.

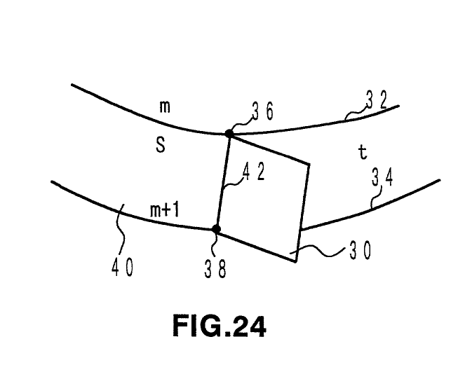

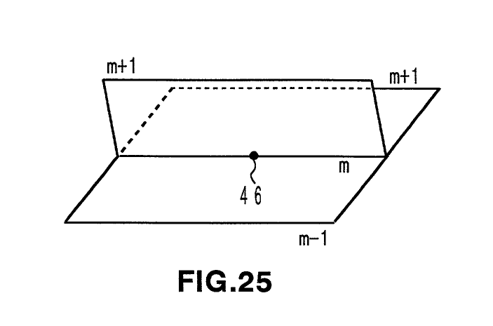

FIGS. 24 and 25 show a part of the surface of a non-manifold object. As shown in FIG. 24, a polygon fragment 30 exists over a triangle strip 40 that is composed of c-edge 32 and c-edge 34, the graph distance values of which are m and m+1 respectively. In this case, the vertices 36 and 38, at which the fragment 30 and the triangle strip 40 intersect, are defined as new c-nodes. The edge 43 between the vertices 36 and 38 divides the triangle strip 40 into two regions indicated by s and t. The separate triangle strips are treated as open annuli. In the Figure the fragment 30 itself is encoded as an open annulus. The vertices 36 and 38 are c-nodes and each of them has three sets of triangles around it. Therefore the code will take the form of “3 (a, b, c)”. As shown in FIG. 25, if a polygon fragment 30 exists in parallel with a triangle strip 40, a new c-node is not provided. Likewise, a code for a vertex 46 will take the form of “3 (a, b, c)”.

In the method of this embodiment, Touma's operators such as add and split are not used, but four operators based on shape components are introduced as follows:

NEW_CNODE: Create a new c-node and move a focus to the c-node;

OLD_CNODE: Move to an existing c-node;

NEW_CEDGE: Create a new c-edge and move to the c-edge; and

OLD_CEDGE: Move to an existing c-edge.

The operators “NEW_CNODE” and “NEW_CEDGE” take as an argument information relating to a set of triangles such as “3 (2, 4, 3)”. The operators “OLD_CNODE” and “OLD_CEDGE” take as an argument the index of the c-node or the c-edge. The non-manifold is thus encoded by the invented method.

Lossy Connectivity Compression

The connectivity information may also be encoded in a lossy way. In the embodiment a toroidal graph representation is introduced to achieve this lossy compression of connectivity. The toroidal graph was first proposed by Fuchs et al., “Optimal Surface Reconstruction from Planar Contours”, Communications of the ACM, 20(10) , pp. 693-702, October, 1977. This toroidal graph is used to generate a triangle mesh between two cross-sections.

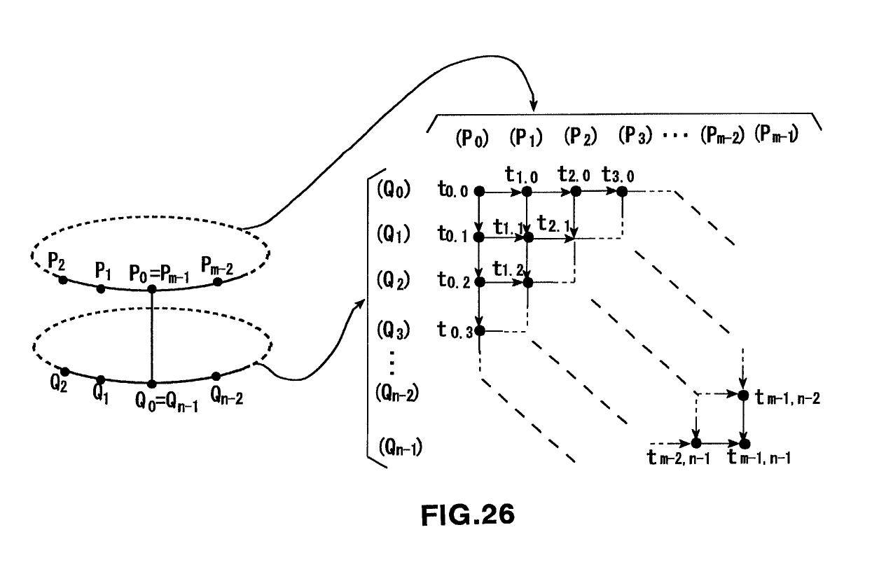

FIG. 26 illustrates the reconstruction of the surface of an annulus or a 2-cell by constructing a toroidal graph. An annulus has two boundaries which consist of the vertex arrays (P₀, P₁, . . . , Pₘ₋₁) and (Q₀, Q₁, . . . , Qₙ₋₁) respectively where the size of the marching pattern is m+n. In the case of a regular annulus, P₀=Pₘ₋₁ and Q₀=Qₙ₋₁ hold. In the embodiment, it is assumed that there are polygon edges connecting P₀−Q₀ and Pₘ₋₁−Qₙ₋₁. Then the toroidal graph has m by n nodes which are denoted t_{i,j} (0<=i<m, 0<=j<n) and each node t_{i,j} in the toroidal graph means the existence of a polygon edge between the vertex Pᵢ and vertex Qⱼ. Each t_{i,j} has two directional edges to adjacent nodes and the edge (t_{i,j} →t_{i+1,j}) indicates the triangle consists of (Pᵢ, Pᵢ₊₁, Qⱼ) , and the edge (t_{i,j}→t_{i,j,+1}) indicates (Pᵢ, Qⱼ₊ᵢ, Qⱼ). Each edge can be assigned a cost calculated based on the area of the triangle or the angle between the adjacent faces. For instance, a smaller cost may be assigned to a triangle with a smaller area or a triangle with a smaller angle to a previous adjacent face.

By constructing the toroidal graph in this way, the reconstruction of a marching pattern can be reduced to the problem of searching the minimum cost path from t_{0,0} to t_{m-1, n-1}. The minimum cost path can be solved by calculating the minimum cost of each node in order according to Dijkstrals algorithm:

t_{1,0}→t_{0,1}→t_{2,0}→t_{1,1}→t_{0,2}→ . . . →t_{m-1,n-2}→t_{m-2,n-1}→t_{m-1,n-1}.

Furthermore, Dr. Shinagawa proposed an extended toroidal graph theory in the dissertation that was introduced as the base techniques. His method is as follows: p1 1. a pair of points that are mutually closest are detected between two contour lines;

2. the closest pair are connected by an edge; and

3. the other corresponding points are obtained by interpolating between the pair of points.

Fuchs' method obtains an optimal path in a discrete manner, but Shinagawa's method is a continuous version of Fuchs' method and can alleviate artificial “wrinkles” on the reconstructed surface that often appears in Fuchs' method. The embodiment may use this extended toroidal graph.

Geometry Compression

The embodiment compresses vertex coordinates based on an approach proposed in “Geometric compression through topological surgery”, ACM Transactions on Graphics, 17(2) , pp. 84-115, April, 1998 by Taubin. Generally, the coordinate values are represented as 32bit floating-point numbers. However, since vertices in a triangle mesh exist in only a limited space, this representation is wasteful. Therefore, considering a bounding box surrounding the object, the float value fᵢ of coordinates of the vertex vᵢ can be rounded to a fixed length value n_{i.} The rounded fixed lengths bₓ, b_{y} and b_{z} are defined for x, y and z coordinates respectively. In experiments, it was found that bₓ, b_{y}, b_{z} of between 9 and 12 bits are sufficient to maintain the quality of meshes that contain fewer than 100,000 triangles. The embodiment also employs a prediction scheme to provide further compression of the rounded values of the fixed length integers. In the encoding of a value of a vertex, the error between the original value and the predicted value calculated from the preceding vertices is coded by Huffman encoding which is an entropy coding.

Although the aforementioned method works well and produces a high compression ratio, it does not take adaptivity of the triangle mesh structure into account. When a mesh has fine and coarse triangles, it is called an adaptive mesh. If the fine parts of the adaptive mesh take on importance, the rounding to fixed length integer is made at the expense of the resolution of the fine parts. In this case, the errors between the original and the prediction values in the coarse parts vary widely, and as a result the performance of the Huffman encoding is degraded.

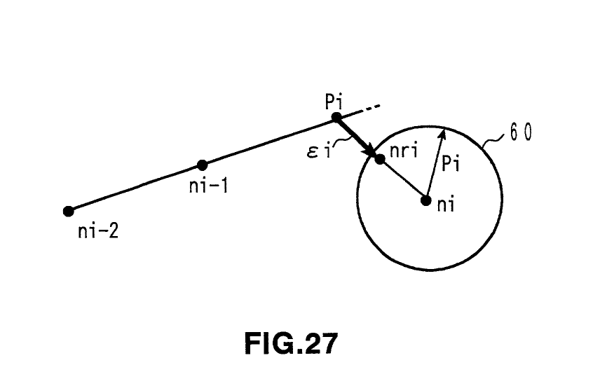

FIG. 27 shows connectivity prediction and compression methods for the adaptive mesh, which are intended to solve the above problem. In FIG. 27, nᵢ₋₂, nᵢ₋₁, nᵢ respectively denote positions defined after the real positions of vertices vᵢ₋₂, vᵢ₋₁, vᵢ are rounded. Pᵢ denotes the position of nᵢ linearly predicted from nᵢ₋₂ and nᵢ₋₁, and εᵢ denotes the error between the predicted Pᵢ and a reference point nᵣᵢ that is explained later.

The embodiment assigns an allowance range 60 of 2aᵢ to the rounded value nᵢ of the vertex vᵢ, that is, the decoded vertex is allowed to take any value in the range [nᵢ−aᵢ, nᵢ+aᵢ]. The range aᵢ is larger when the vertex vᵢ is in a coarse part, and is smaller when the vertex vᵢ is in a fine part.

Thus, the compression of an adaptive mesh is reduced to the problem of how to decide the error εᵢ that has as small a Huffman code as possible while satisfying the condition Pᵢ+εᵢ∈[nᵢ−aᵢ, nᵢ+aᵢ] so that the reference point nᵣᵢ (being Pᵢ+εᵢ)can be within the allowance range 60. In order to solve this problem, a step number sᵢ based on aᵢ is defined as follows:

sᵢ=2^{β}

where β is the maximum integer value that does not exceed log₂2aᵢ. The step number sᵢ takes the form of 2ⁿ where n is an integer value and is the largest number below the allowance range 2aᵢ. The εᵢ is then calculated using the sᵢ as follows:

εᵢ=eᵢsᵢ, where eᵢ∈N is a unit vector.

Such εᵢ values are uniquely determined and the εᵢ is then encoded by Huffman encoding. Note that the step number sᵢ can be regarded as the resolution of each mesh and therefore the Huffman encoding based on all of the steps sᵢ is equivalent to encoding each value at different resolution. Thus, effective compression for an adaptive mesh can be achieved.

In the compression of the vertex coordinates, the allowance range parameter aᵢ is calculated using the normal vector normᵢ of the vertex vᵢ, the minimum value 1 minᵢ of the distances to adjacent vertices, and an adaptive parameter α specified by a user as follows:

aᵢ=(1 minᵢ/60 )|normᵢe_{x|y|z}|

where the parameter aᵢ is calculated for x, y and z coordinates individually and the e_{x|y|z} denotes the unit vectors at each coordinate.

The adaptive parameter α is greater than zero so that the parameter aᵢ becomes larger as the α becomes smaller. That is, a small α makes the compression sensitive to the adaptivity of a mesh and provides a high compression ratio but the decoded object is constructed with poorer quality. The normal vector normᵢ is used to restrain the vertex from shifting in the normal direction because a normal shift is more perceptible than an orthogonal shift, especially for vertices on a nearly flat surface.

According to our experiments, an adequate value for α is 8 or 16 or more, and for more bumpy mesh data, occasionally a value of about 4 is sufficient. This is because shifts of coordinates in a bumpy mesh are less conspicuous than in a smooth mesh. Such features of a mesh should be considered when the adaptive parameter α is decided.

Note that the aforementioned method is only one example of the ways to obtain the parameter aᵢ. Furthermore, this adaptive mesh approach can be applied to other geometrical information such as texture coordinates, normal vectors, colors, and reflection property.

Encoding and Decoding Procedures

The embodiment uses the following input parameters for encoding a mesh and controlling the quality and compression ratio:

v={vᵢ₁, vᵢ₂, . . . }: the array of base vertices;

bₓ, b_{y}, b_{z}: the rounding bit length of each coordinate;

α: the adaptivity parameter.

For encoding topology information, the input parameter v is used. Although the parameter v sometimes affects the compression ratio, it is usually sufficient to simply specify an arbitrary vertex. For encoding geometrical information, the input parameters bₓ, b_{y}, b_{z} and α(>0) are used.

Once the input parameters have been specified, a triangle mesh is encoded through the following steps:

Step 1: Construction of shape components.

In this step, a base vertex v is specified and a continuous function relating to graph distance is determined. Then an object is decomposed into shape components. p1 Step 2: Geometry compression.

The coordinate values are rounded to bₓ, b_{y} and b_{z} bits, and then compressed by the adaptive prediction scheme using the parameter α.

Step 3: Topology compression.

The marching patterns are compressed using toroidal graphs.

It is important that the geometry compression is performed before the marching pattern compression because the computation of toroidal graphs depends on the coordinate values of each vertex. In the decoding phase the toroidal graph cannot refer to the original geometry values, but refers to the encoded values only. Therefore it is necessary to use the encoded geometry values in the encoding phase.

The decoding follows the same steps as the encoding process; i.e., (1) decoding the shape components, (2) decoding the geometry values, and (3) decoding the marching patterns.

In order to test the effectiveness of the embodiment, polygon objects of 20 to 900 kilobytes in VRML 1.0 (ASCII form) were processed. In this experiment, the amount of data is reduced by one to two digits while the degradation of the image quality is almost imperceptible. The time required for encoding and decoding was fairly fast, ranging from 0.5 to 100 seconds. The experiment was performed using an MMX Pentium™ 266MHz personal computer with a Linux operating system. The connectivity information using the toroidal graph was compressed into less than one bit. The number of bits per triangle was less than 0.2 in the best case.

In the embodiment, it is not necessary to wait until the completion of decoding in order to display an object, since the decoded parts can be displayed sequentially. Therefore the embodiment is suitable for a progressive display. Now that the general concept and procedures of the embodiment have been described, the structure of the embodiment is now explained.

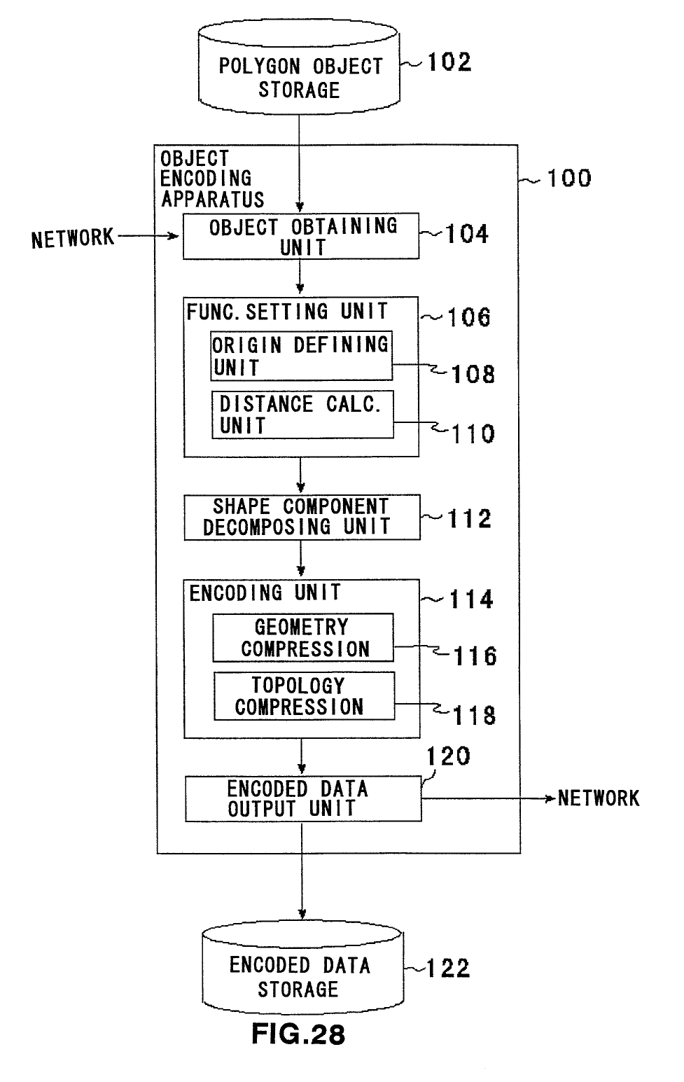

FIG. 28 shows the structure of an object encoding apparatus 100 according to an embodiment of the invention. An object obtaining unit 104 receives the polygon mesh of an object from a polygon object storage 102, which may be local storage or on a network or the like. A function setting unit 106 sets a function relating to a graph distance on a surface defined by the input polygon mesh. The function setting unit 106 includes an origin defining unit 108 that defines a base vertex (or base vertices) as a starting point or an origin from which the graph distance is defined, and a distance calculating unit 110 that calculates a graph distance from the base vertex to each vertex on the polygon mesh.

A shape component decomposing unit 112 decomposes the polygon mesh into its shape components, and an encoding unit 114 encodes each of the shape components. Since the function relating to the graph distance can be regarded as a Morse function described in the base techniques above, the encoded data of each shape component includes global structure or topology information of the object in the form of a Reeb graph. The encoding unit 114 includes a geometry compression unit 116 that compresses and encodes the geometry information of the polygon mesh, and a topology compression unit 118 that compresses the connectivity information of the polygon vertices. An encoded data output unit 120 outputs the encoded data to an encoded data storage 122, which may be local storage or on a network or the like.

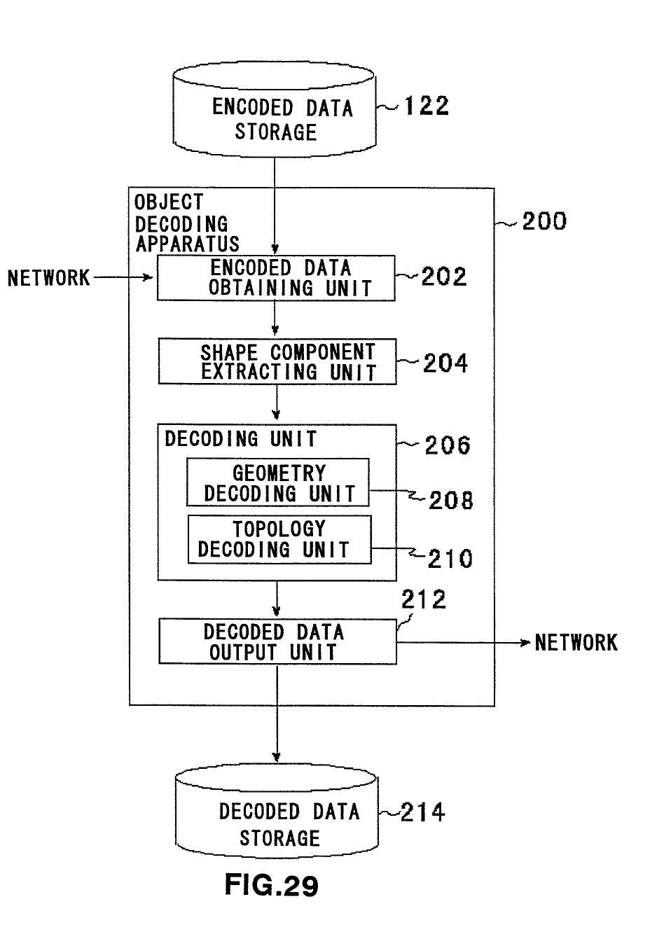

FIG. 29 shows the structure of an object decoding apparatus 200 according to the embodiment. An encoded data obtaining unit 202 receives the encoded data of an object from an encoded data storage 122, which may be local storage or on a network or the like. A shape component extracting unit 204 extracts the shape components of the object from the input encoded data. A decoding unit 206 decodes each of the extracted shape components. The decoding unit 206 includes a geometry decoding unit 208 that reconstructs the geometry information of the polygon mesh, and a topology decoding unit 210 that reconstructs the connectivity information of the polygon vertices. A decoded data output unit 212 outputs the decoded data to a decoded data storage 214, which may be local storage or on a network or the like.

The encoding and decoding procedures performed by the elements in the above configuration have been described herein. Note that the encoding and decoding procedures of the present invention can also be recorded as a computer program and stored in various storage media for distribution, or such a program can be provided via various transmission methods.

For the object encoding and decoding of the embodiment, various modifications can be applied. First, the embodiment assumes that an object is represented in a polygon mesh but this is not intended to be a restriction. For instance, the object may also be represented as a free surface or represented analytically. The object may also be represented using a boundary representation method or represented in constructive solid geometry (CSG). The present invention can also be applied to such object representations. In these cases, a starting point is provided on the surface of the object and the function is defined on the surface. The shape components can also be generated based on the function values and encoded.

Secondly, in the embodiment, the starting point or the origin is provided on the surface of the object, but the origin may also be taken from outside or inside of the object. In this case, a distance from the origin to each point can be adopted for the function instead of a graph distance.

Note also that each of the elements of the procedures and of the encoding apparatus and decoding apparatus discribed above may be realized by software and/or hardware.

Although the present invention has been described by way of exemplary embodiments, it should be understood that those skilled in the art might make many changes and substitutions without departing from the spirit and the scope of the present invention that is defined by the appended claims.

What is claimed is:

1. An object encoding method comprising:
obtaining a description of a surface of an object;
defining an origin on the surface;
decomposing the surface into a plurality of independent shape components according to a distance from the origin to a point of the surface; and
encoding the shape components.

2. The method of claim 1, wherein the description takes a form of a polygon mesh, the origin is a predefined base vertex in the polygon mesh, and the distance is a graph distance from the base vertex to a vertex of the polygon mesh.

3. The method of claim 2, wherein shape components include a contour graph which is a set of edges that connect between vertices that have the same graph distance.

4. The method of claim 3, further comprising ensuring that the object has validity as a closed surface by applying an Euler equation to a contour node and a contour edge which are extracted from the contour graph.

5. The method of claim 2, wherein the base vertex is a plurality of base vertices and the graph distance of a specific vertex is defined as a minimum value of the graph distances from the plurality of base vertices to the specific vertex.

6. The method of claim 2, wherein the shape components include an annulus.

7. The method of claim 2, wherein the shape components include a two-dimensional cell.

8. The method of claim 6, wherein the annulus takes the form of a triangle strip.

9. The method of claim 7, wherein the two-dimensional cell takes the form of a triangle strip.

10. The method of claim 9, wherein the two-dimensional cell is an independent region, only one boundary of which connects between vertices with a graph distance m, where m is a natural number.

11. The method of claim 8, wherein the annulus is an independent region, one boundary of which connects between vertices with a graph distance m and another boundary of which connects between vertices with a graph distance m+1, where m is a natural number.

12. The method of claim 2, wherein shape components include global topological information of the object.

13. The method of claim 12, wherein the global topological information is specified by a structural graph obtained on a basis of the graph distance.

14. The method of claim 13, wherein the structural graph is a Reeb graph known in differential topology.

15. The method of claim 2, wherein said encoding the shape components includes encoding geometrical information of the object and encoding local topological information of the object.

16. The method of claim 15, wherein said encoding the local topological information includes a description indicating that the object is a non-manifold when a shape represented by the polygon mesh is a non-manifold.

17. The method of claim 16, wherein the description describes the number of sets of polygons around a vertex that characterizes the non-manifold.

18. The method of claim 15, wherein said encoding the geometrical information adapts to a local size of the polygon mesh.

19. The method of claim 15, wherein said encoding the geometrical information is performed through an entropy coding of a difference between a predicted value and a real value of the geometrical information to be encoded.

20. The method of claim 19, further comprising adjusting the difference to optimize the entropy coding.

21. The method of claim 20, wherein the adjusting includes:
assigning an allowance range to the real value;
detecting a reference value within the allowance range to minimize an amount of the encoded difference between the predicted value and the reference value; and
replacing the difference between the predicted value and the real value by the difference between the predicted value and the reference value.

22. The method of claim 21, wherein the allowance range is defined by adapting to the size of the polygon mesh relating to the geometrical information to be encoded.

23. An object encoding apparatus comprising:
a unit which obtains a description of a surface of an object;
a unit which defines an origin on the surface;
a unit which decomposes the surface into a plurality of independent shape components according to a distance from the origin to a point of the surface; and
a unit which encodes the shape components.

24. The apparatus of claim 23, wherein the description takes a form of a polygon mesh, the origin is a predefined base vertex in the polygon mesh, and the distance is a graph distance from the base vertex to a vertex of the polygon mesh.

25. The apparatus of claim 23, wherein shape components include global topological information of the object.

26. The apparatus of claim 23, wherein the unit which encodes the shape components includes a unit that encodes geometrical information of the object and a unit that encodes local topological information of the object.

27. An object encoding method comprising:
obtaining an object;
defining a function on a distance on a surface of the object;
obtaining a structural graph of the object on a basis of a value of the function; and
encoding the object in such a form that the structural graph is included.

28. The method of claim 27, wherein the object is represented as a polygon mesh and the function outputs a graph distance from a predefined base vertex in the polygon mesh to a vertex of the polygon mesh.

29. The method of claim 277 wherein the structural graph represents a critical point of the function as a node.

30. An object encoding method comprising the steps of:
obtaining a description of a surface of an object;
defining an origin on the surface;
decomposing the surface into a plurality of independent shape components according to a distance from the origin to a point of the surface; and
encoding the shape components.

31. An object encoding method comprising the steps of:
obtaining an object;
defining a function on a distance on a surface of the object;
obtaining a structural graph of the object on a basis of a value of the function; and
encoding the object in such a form that the structural graph is included.

32. An object decoding apparatus comprising:
an obtaining unit which obtains encoded data of an object;
an extracting unit which extracts a plurality of independent shape components from the encoded data, wherein said plurality of independent shape components were encoded after being decomposed according to a distance from an origin of the surface, which is included in the encoded data, to a point of the surface of the object;
a decoding unit which decodes each of the extracted shape components and reconstructs geometry and topology information of the object; and
an output unit which outputs a decoded representation of the object.

33. An object decoding method comprising:
obtaining encoded data of an object;
extracting a plurality of independent shape components from the encoded data, wherein said plurality of independent shape components were encoded after being decomposed according to a distance from an origin of the surface, which is included in the encoded data, to a point of the surface of the object;
decoding each of the extracted shape components;
reconstructing geometry and topology information of the object; and
outputing a decoded representation of the object.
